(19) United States
(12) Patent Application Publication
(10) Pub. No.: US 2019/0095808 A1
(43) Pub. Date: Mar. 28, 2019

(54) METHODS AND APPARATUS TO DYNAMICALLY ADJUST AN ANALYTICS THRESHOLD

(71) Applicant: Intel Corporation, Santa Clara, CA (US)

(72) Inventors: Rita Chattopadhyay, Chandler, AZ (US); Kalpana Algotar, Chandler, AZ (US)

(21) Appl. No.: 15/717,227

(22) Filed: Sep. 27, 2017

(51) Int. Cl. G06N 7/00; G06Q 10/06; G06N 99/00

(52) U.S. Cl. CPC G06N 7/005; G06N 99/005; G06Q 10/0635

(57) ABSTRACT

Apparatus and methods to dynamically adjust an analytics threshold are disclosed. An example method includes analyzing a set of probabilities of injury to determine minimum and maximum probability in the set based on a request for an injury risk for a target player; determining possible thresholds to divide the probabilities of injury between the minimum and maximum probability; converting the probabilities of injury into percentages of injury based on at least one of the possible thresholds; distributing the percentages of injury into a plurality of bands based on the possible threshold(s); comparing the percentages of injury in each of the plurality of bands according to a criterion; and when the criterion is satisfied, updating a target threshold to classify the injury risk for the target player based on at least one of the possible thresholds dividing the percentages of injury in the plurality of bands and outputting the injury risk for the target player.

### FIELD OF THE DISCLOSURE

The present disclosure relates generally to machine-based data processing and, more particularly, to methods and apparatus to dynamically adjust an analytics threshold.

### BACKGROUND

Many decisions today are driven by analytics. Data and analysis of that data are important, but technological hurdles remain barring effective use of that data in certain situations, environments, etc. For example, sports are played on many levels ranging from youth sports to national and international professional-level sports. In many levels of competition, player and team statistics are often collected to memorialize past player and team performances. Many fans use such statistics data to follow the progress of players and teams during a sports season. Such statistics can also be used by teams and/or the players to generate play/competition strategies, build teams, negotiate contracts, etc. In addition, such statistics can also be used by business organizations to make decisions on athlete sponsorships, team sponsorships, how to spend advertising dollars related to sporting events, etc. However, rigid computing structures and preset comparisons severely limit generation and applicability of such statistics.

### BRIEF DESCRIPTION OF THE DRAWINGS

FIG. 1 depicts an example injury prediction apparatus.

FIG. 2 depicts an example injury prediction apparatus including a dynamic threshold generator.

FIG. 3 depicts an example implementation of the threshold generator of FIG. 2.

FIG. 4 illustrates an example plot of injury versus threshold according to the apparatus of FIGS. 1-3.

FIG. 5 illustrates an example prediction performance table showing accuracies of injury predictions generated by the example apparatus of FIGS. 1-3.

FIGS. 6-8 illustrate example tables of dynamic thresholding results according to the example apparatus of FIGS. 2-3.

FIGS. 9-13 are flow diagrams representative of example machine readable instructions that may be executed by a processor to perform predictive analytics including dynamic thresholding to predict probabilities of sports injuries in accordance with FIGS. 1-3.

FIG. 14 is an example processor platform capable of executing the example computer readable instructions represented by FIGS. 9-13 to implement the example apparatus of FIGS. 1-3.

The figures are not to scale. Wherever possible, the same reference numbers will be used throughout the drawing(s) and accompanying written description to refer to the same or like parts.

### DETAILED DESCRIPTION

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized and that logical, mechanical, electrical and other changes may be made without departing from the scope of the subject matter of this disclosure. The following detailed description is, therefore, provided to describe an exemplary implementation and not to be taken as limiting on the scope of the subject matter described in this disclosure. Certain features from different aspects of the following description may be combined to form yet new aspects of the subject matter discussed below.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

As used herein, the terms “system,” “unit,” “module,” “engine,” etc., may include a hardware and/or software system that operates to perform one or more functions. For example, a module, unit, or system may include a computer processor, controller, and/or other logic-based device that performs operations based on instructions stored on a tangible and non-transitory computer readable storage medium, such as a computer memory. Alternatively, a module, unit, engine, or system may include a hard-wired device that performs operations based on hard-wired logic of the device. Various modules, units, engines, and/or systems shown in the attached figures may represent the hardware that operates based on software or hardwired instructions, the software that directs hardware to perform the operations, or a combination thereof.

Overview

Condition monitoring and alert generation based on a predetermined threshold, computed based on an offline analysis of healthy and faulty data, is a method used for anomaly or fault detection. One offline analysis method is creation of a Receiver Operating Characteristics (ROC) curve of data collected during a certain period of time. The curve is generated by plotting a true positive rate (TPR) against a false positive rate (FPR) at various threshold settings, and a threshold that provides the best TPR with minimum FPR is selected as an operating threshold value. A problem with this method is that the selected threshold guarantees the design TPR over the time period that the data was collected. However, the design TPR is not correct from the first data read of the system. For example, in situations where a distribution of the healthy and faulty data varies with time and a probability of faults increases with time, initial or early data values are not properly analyzed using a preselected or set threshold value.

One such case is injury prediction for players (e.g., sports-related injuries for athletes, etc.). Injuries happen more during the latter part of a sport's season, when the players are relatively more fatigued, stressed and have already experienced past injuries, rather than at the start of the season when players are fresh. As a result, thresholds set with respect to probabilities of injury in order to categorize such probabilities of injury as ‘Normal’, ‘Elevated’, and ‘Significant’ that are computed based on a complete season's data do not provide satisfactory performance for the earlier part of the season because a probability of injury is overstated. By contrast, the same data set may understate a probability of injury later in the season. For example, ‘Normal’ refers to a lower probability of injury, and ‘Significant’ refers to a higher probability of injury, with ‘Elevated’ being an intermediate stage of injury probability. These categories are defined based on a percentage of injured players belonging to each category. However, true positive rates are observed to be lower during the early part of the season. Such fixed category thresholds suffer from a ‘cold-start’ issue because the categories require a certain amount of data to be collected or time elapsed within the season to provide acceptable performance in terms of prediction accuracy, for example.

Conversely, examples disclosed herein compute thresholds online in real time (or substantially real time given data storage, retrieval, processing, and/or transmission latency) to help ensure a high prediction accuracy throughout a sports season (e.g., from start to finish). Examples disclosed herein dynamically determine bands or categories of risk, for example, through adaptive adjustment of analytical thresholds defining and/or otherwise separating the bands/categories. Examples disclosed herein enable a characterization of risk (e.g., injury risk, other analytic, etc.) by classifying the target player according to a band of injury risk based on a comparison of the target player to one or more other players that have satisfied or failed to satisfy one or more thresholds to be categorized with a certain risk in a certain band.

Injuries to athletes (e.g., in-game/in-competition injuries) are quite common. Such injuries range from minor bruises to fatal injuries. Injuries affect the morale of the players and the team. Such injuries can also cause significant financial losses to the sports organizations by way of salary losses, medical expenses, losses due to reduced fan attendance, etc. Examples disclosed herein may be used to decrease a likelihood of injuries and/or an impact of such injuries on athletes, teams, and/or sports organizations through an improved quantification and threshold analysis of probabilities of injury.

Examples disclosed herein may be used to predict occurrences of sports injuries. Examples disclosed herein may be used for a plurality of sports (e.g., basketball, baseball, American football, soccer (international futbol), lacrosse, rugby, cricket, boxing, volleyball, swimming, tennis, track and field, etc.). For example, techniques disclosed herein may be used to predict in-game injuries in a participant (e.g., an athlete, a player, a participant, etc.) before a particular game or competition. Disclosed examples include a predictive framework that uses cognitive technologies and methods to identify similar participants and associated probability of injury based on dynamically determined thresholds for particular times of year, points in the season, games played, etc.

Examples disclosed herein include a cognitive framework that uses an associative memory base (AMB) (e.g., an associative database that may be based on Saffron's associative memory base technology developed and provided by Saffron Technology of Los Altos, Calif., an Intel Company), which identifies similar participants based on associations of different attributes, measured using a Kolmogorov Complexity distance measure.

Disclosed examples predict the probability of injury of a target participant, based on the injury data distribution of a top number of N (e.g., five, or any other number) most similar athletes and similarity factors of those similar participants organized according to dynamically determined category thresholds. Some examples disclosed herein related to predicting injuries for basketball players. However, examples disclosed herein may additionally or alternatively be used in connection with other sports.

Disclosed examples may be used to prevent player injuries, thus, enabling better team health and game schedule management. Disclosed examples may also be used to improve revenue generated by advertising, fan attendance and merchandising.

Disclosed examples leverage empirical evidence that in-game injuries in athletes are a byproduct of the athletes' physiological load and mechanical load as well as time of year, point in the season, number of games played, etc. In examples disclosed herein, physiological load is an accumulative value representing physiological load on an athlete, involving distance traveled, average speed and the athlete's weight. In examples disclosed herein, mechanical load is an accumulative value representing mechanical load on an athlete's body and accelerations and decelerations. These factors are in-turn dependent upon a player's fitness level, which has a significant impact on the chances of the athlete sustaining an injury. Examples disclosed herein use athletes' histories of previous injuries as a predictor of future injuries. Certain examples provide a more accurate assessment of injury and probability threshold at any point through a season, year, etc.

Examples disclosed herein are useful and technologically improved over prior solutions by dynamically computing thresholds for probability of injury, triggered by a request to predict player injury. Thresholds are dynamically computed based on a definition for each available category. Certain examples dynamically compute thresholds online based on available data read and/or otherwise accessed up to a certain date (e.g., the date of the request, an end of month prior to the request, and of quarter prior to the request, end of season prior to the request, etc.). The data can be accessed for threshold determination and/or other calculation in real time (or substantially real time given data storage, retrieval, processing, and/or transmission latency), and thresholds can be based on an application-specific cost function and/or defined by percentages of injured players that are to belong in each category. Thus, dynamically determined thresholds can continue to vary as more and more data (e.g., game data, etc.) is added to a source database (e.g., a sports database, etc.) and satisfies an associated application-specific cost function for the data up to a target date. For example, the application-specific cost function can include approximately two percent (˜2%) of injured players in a ‘Normal’ category/band, ˜5% of injured players in an ‘Elevated’ category/band, and >7% of injured players in a ‘Significant’ category/band. Therefore, if a player is predicted to be ‘Normal’, the categorization indicates that the player belongs to a category in which only 2% players were injured, whereas, in the Elevated band, ˜5% players were injured, and, in the ‘Significant’ category/band, >7% players were injured. The stratification or categorization of player injury by threshold holds true throughout the season and/or other monitoring time period, irrespective of an amount of available data, time in season, number of games played, etc.

Thus, using sports domain knowledge, certain examples convert a probability of injury into a plurality of bands such as Normal, Elevated, and Significant, etc. In certain examples, the normal band represents a “safe” band. That is, the normal band should include a lower percentage of injury when compared to the elevated and significant bands. The significant band, for example, represents a “critical” band including players who are more prone to injury. The significant band contains a high percentage of injury when compared to the normal and elevated bands.

To allocate a probability of injury to each band, the probability of injury is transformed using a compute probability function to generate a meaningful percentage value. An optimal and/or otherwise improved threshold value can be determined by analyzing a distribution of probability in each band/category. A threshold value can be determined based on one or more conditions including condition(s) related to band/category distribution.

For example, a number of players in the normal band should be greater than a number of players in the elevated and significant bands. Similarly, a number of players in the elevated band should be more than a number of players in the significant band, for example.

Alternatively or in addition, a percentage of injury in the normal band should be less (e.g., ˜2%, ˜4%, etc.) compared to a percentage of injury in the elevated and significant bands, for example. A percentage of injury in the significant band should be more than a percentage of injury in the normal and elevated bands. In certain examples, a percentage of injury should be double in the elevated band (e.g., ˜5%, ˜6%, etc.) compared to the normal band and a percentage of injury should be double in the significant band compared to the elevated band (e.g., >7%, >9%, etc.).

Thus, certain examples provide dynamic threshold logic to automatically determine threshold value(s) between bands or categories. Certain examples eliminate traditional plotting of an ROC to determine a threshold value. Certain examples can also be scaled based on amount of data, number of categories, range of probabilities, etc.

Example Systems and Methods For Injury Analysis and Prediction

As described above, systems and methods for dynamic threshold determination can be applied to a variety of contexts, applications, data, etc., having a variety of probabilities. One particular example used to illustrate the systems and methods is player injury.

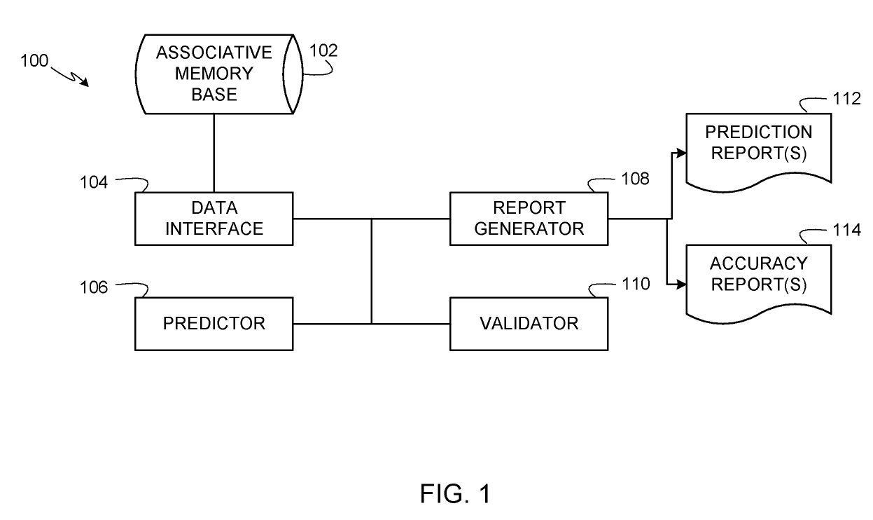

FIG. 1 depicts an example apparatus 100 to generate sports injury predictions. The example apparatus 100 includes an example data interface 104, an example predictor 106, an example report generator 108, and an example validator 110. In the illustrated example, the data interface 104 is in communication with an associative memory base (AMB) 102 and may query the AMB 102 using, for example, JavaScript, python, etc. The example AMB 102 is an associative database or data structure that stores player performance data parameters in an associative manner on a large number of players that participate in a sports league. Example player performance data parameters include physiological load (physio_load), mechanical load (mechanical_load), mechanical intensity (mechanical_intensity), physical intensity (physical_intensity), number of games played (games_played), average running seconds (avg_seconds), average field goals (avg_field_goals), previous injuries (prev_injuries), position played, seconds played, average/moving average of seconds played, seconds played from a previous season, venue played, venue floor type, specific competitive division, venue temperature, player temperature, perspiration amount, type of shoes worn, types of protective gear worn, injuries incurred against particular opponents, opponent's playing style (e.g., offensive alignment, defensive alignment), player age, player's physical attributes (e.g., height, weight, arm reach, finger length, body mass index (BMI), electrocardiogram (ECG) measures, diastolic blood pressure, systolic blood pressure, etc.), all-star status, most valuable player (MVP) status, playing style (e.g., offensive, defensive, aggressive, high-contact play, low-contact play, shot blocking, etc.). In other examples, fewer, more, and/or different performance data parameters may be stored by the AMB 102 for use in accordance with the teachings of this disclosure. In some examples, performance data parameters can be selected for use with techniques disclosed herein based on empirical analysis of what types of performance data produce high prediction accuracies for sports injuries. In some examples, some performance data parameters may be selected based on whether they contribute to a player's level of muscle fatigue. In some examples, performance data parameters may be selected based on secondary effects that may create higher probabilities of injury. For example, venue temperature, player temperature, and/or perspiration amount may be indicative of excessive player perspiration that creates slippery floors, which could lead to higher probabilities of slip and fall injuries. In some examples, performance data parameters may include the ability of venue staff to address venue conditions (e.g., slippery floors, humidity, temperature, etc.) in an effective manner to lessen the likelihood of sports injuries arising from such venue conditions. Examples disclosed herein use relationship strengths (e.g., similarities) between the player performance data parameters of different players represented in the AMB 102 to predict probabilities of sports injuries of target players. The AMB 102 may be implemented using Saffron's associative memory base technology developed and provided by Saffron Technology. In some examples, the AMB 102 is part of the apparatus 100, while in other examples the AMB 102 is implemented separate from the apparatus 100.

The data interface 104 of the illustrated example obtains player performance data parameter values for target participants and similar athletes from the AMB 102. In the illustrated example, the data interface 104 obtains data from the AMB 102 for a specified number (e.g., five, ten, etc.) of most similar athletes (e.g., athletes most similar in performance data to the target participant). The AMB 102 of the illustrated example measures similarities between the target participant's records and records of other players represented in the database based on associations measured using Kolmogorov Complexity and returns identifiers (IDs) of the specified number of most similar athletes along with their similarity factors.

The example predictor 106 performs predictive analytics, which computes the probability of in-game injury of the target participant based on the performance data parameters of the target participant and similar athletes (e.g., past injuries, game records, etc. of the target participant and the similar athletes) obtained by the data interface 104 from the AMB 102, and based on the similarity factors between the target participant and the similar athletes.

The example report generator 108 generates example injury prediction reports 112 providing probabilities of injuries of target participants predicted by the predictor 106 for target game/competition dates. The example report generator 108 also generates example accuracy reports 114 on the accuracies of past predictions. For example, after a target game/competition date, the validator 110 assesses the accuracies of injury predictions determined by the predictor 106 for target participants on the target game/competition date. After determining accuracies, the report generator 108 can generate the accuracy reports 114 showing percentages or degrees of accuracy between the injury predictions and actual injuries of target participants.

While an example implementation of the apparatus 100 is illustrated in FIG. 1, one or more of the elements, processes and/or devices illustrated in FIG. 1 may be combined, divided, re-arranged, omitted, eliminated and/or implemented in any other way. Further, the example AMB 102, the example data interface 104, the example predictor 106, the example report generator 108, the example validator 110 and/or, more generally, the example apparatus 100 of FIG. 1 may be implemented by hardware, software, firmware and/or any combination of hardware, software and/or firmware. Thus, for example, any of the example AMB 102, the example data interface 104, the example predictor 106, the example report generator 108, the example validator 110 and/or, more generally, the example apparatus 100 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example AMB 102, the example data interface 104, the example predictor 106, the example report generator 108, and/or the example validator 110 is/are hereby expressly defined to include a tangible computer readable storage device or storage disk such as a memory, a digital versatile disk (DVD), a compact disk (CD), a Blu-ray disk, etc. storing the software and/or firmware. Further still, the example apparatus 100 may include one or more elements, processes and/or devices in addition to, or instead of, those illustrated in FIG. 1, and/or may include more than one of any or all the illustrated elements, processes and devices.

Example Systems and Methods for Dynamic Thresholding With Injury Analysis and Prediction

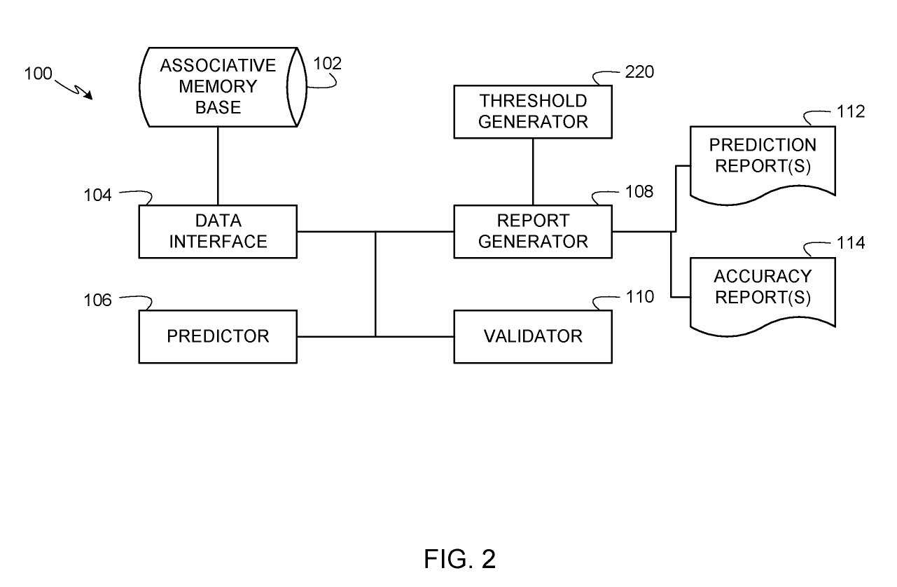

FIG. 2 illustrates an implementation of the example apparatus 100 of FIG. 1 further including a threshold generator 220. The example threshold generator 220 of FIG. 2 processes data from the report generator 108 obtained via the data interface 104, predictor 106, and validator 110, for example. Based on the gathered data, the threshold generator 220 generates one or more thresholds to categorize the data according to a degree of risk (e.g., significant, elevated, normal, etc.) and/or other criterion, for example. Categories can be generated based on the example predictor 106, example validator 110, provided via the example data interface 104, etc. Based on the available data and categories, the threshold generator 220 dynamically generates thresholds to delineate the categories or bands from one another (and assign player injury statistics to respective bands based on which threshold is satisfied, etc.), for example.

For example, a computed probability of injury can be determined for each available player via the predictor 106, validator 110, and report generator 108. However, in isolation, the probability of injury may not be as meaningful because it is unclear how to interpret a 60% chance of injury, for example. In most games, for example, a given player is not injured and, therefore, has a low chance of injury (e.g., 1%, 5%, etc.). Instead, an indication of relative risk can be more instructive (e.g., low risk, medium risk, high risk, etc.). Thus, risk bands (also referred to as categories, groups, etc.) can be created from the available injury data. By categorizing a player's injury probability using the threshold generator 220, the apparatus 100 can determine whether a player has a high risk, low risk, or medium risk of injury during a game (e.g., rather than a particular percentage).

In certain examples, to create risk bands (e.g., low, medium, high, etc.), the threshold generator 220 processes probabilities determined by the predicator 106 and validated by the validator 110 and maps probabilities to threshold(s). The threshold generator 220 classifies available injury data according to the threshold(s) to create risk band(s) in which to group, organize, categorize, and/or otherwise classify the injury data. For example, the threshold generator 220 can determine a threshold at a probability of 60% wherein a value below the threshold is a normal probability of injury and a value above the threshold is a high probability of injury. The threshold can be determined using a line slope formed from a comparison of thresholds to probabilities of injury.

While a static threshold provides results for a full season of data, it fails to provide reliable results at the beginning of a season with data available for only a few games. Early-season analysis does not provide a good data distribution, so people got injured but everyone is grouped in the low probability of injury band because so few games have been played. Conversely, a dynamic threshold provides a technological improvement to process data to generate thresholds and dynamically refine them based on the available data, rather than simply selecting static thresholds for use. In certain examples, the threshold generator 220 processes the available data (e.g., cases of player injury, etc.) and divides the data into categories based on probability (e.g., how many low probability of injury cases, medium probability of injury cases, high probability of injury cases, etc.) and uses information regarding the data in each category to dynamically determine thresholds which inform a level of risk to players, for example, that match players and/or other circumstances found in each category.

For example, the threshold generator 220 processes player injury data from the month of October including a number of games played for a particular sport and a number of injuries that occurred in those games. Each case is organized according to a low, medium, or high probability of injury occurrence. Thresholds which then divide injury likelihood into different risk categories or bands (e.g., low risk, medium risk, high risk, etc.) can then be dynamically determined by the threshold generator 220 based on one or more criteria such as number of games, amount of time covered (e.g., how many days, how many weeks, how many months, etc.), etc. Then, a person (e.g., a new player not included in the evaluated data set) can be processed to determine his or her probability of injury. Based on the determined probability, the person can be evaluated to determine in which band he or she lies. For example, players in the normal band have a 2-5% probability of injury, while players in the significant band have a 10-12% probability of injury. If the person's probability of injury is 10%, then he or she has a significant risk of injury for the month of October, for example. Thus, band criteria/thresholds can be determined dynamically by the threshold generator 220 based on the distribution of available data, for example. For example, if four people were injured in October out of thirty games, the four games are divided into low, medium, and high risk, and the person is evaluated to determine whether he or she is low, medium, or high risk based on the dynamically computed thresholds between categories. Thus, a distribution between low, medium, and high risk bands can be kept consistent throughout the season/year by dynamically adjusting the thresholds to ensure the same distribution of cases, for example.

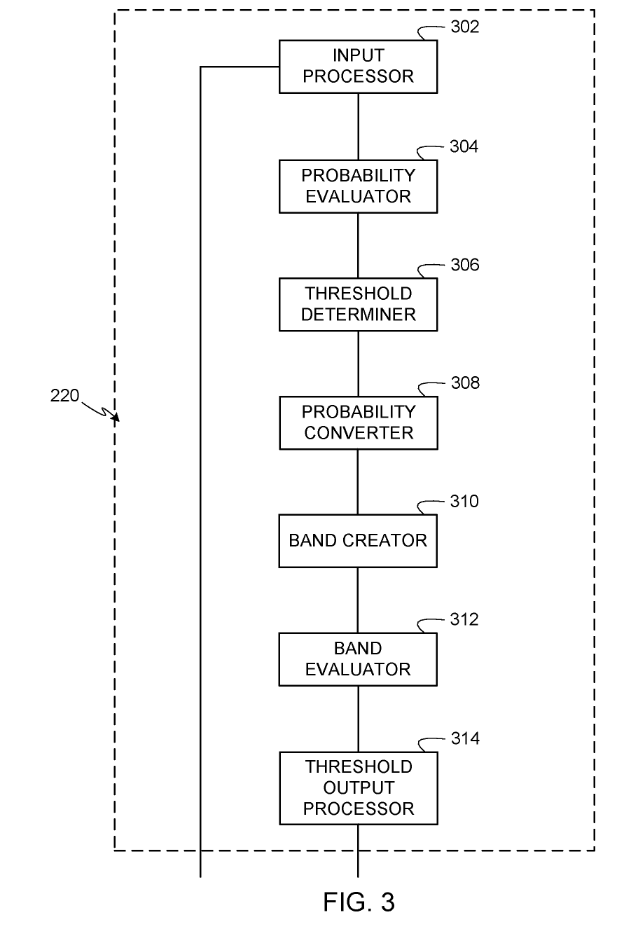

FIG. 3 illustrates an implementation of the example threshold generator 220 of FIG. 2. As shown in the example of FIG. 3, the threshold generator 220 includes an input processor 302, a probability evaluator 304, a threshold determiner 306, a probability converter 308, a band creator 310, a band evaluator 312, and a threshold output processor 314.

In brief, the example input processor 302 receives an input including probability of injury and actual injury status information. The example probability evaluator 304 evaluates the probability information to determine minimum and maximum probability, and the example threshold determiner 306 determines, based on the minimum and maximum probability information, a list or set of possible thresholds to organize the information. The example probability converter 308 receives probability and threshold information and generates a percentage of injury with associated threshold information. The example band creator 310 distributes the percentage of injury into a plurality of bands with associated thresholds. The example band evaluator 312 analyzes the bands and associated thresholds in comparison to current, prior, or preset threshold values to determine optimal or improved threshold value(s). The example threshold output processor 314 outputs the optimal and/or otherwise improved threshold value(s) such as for use by the report generator 108.

More specifically, the example input processor 302 receives an input including probability of injury and actual injury status information. For example, a first input of a probability of injury can be calculated for both a target player and a similar player, and an average of the two probabilities can be calculated. A second input is “ground truth” that indicates a player's actual injury status which shows that either the player is actually injured or is not. The example probability evaluator 304 evaluates the probability information to determine minimum and maximum probability from an array of injury probabilities based on the input probability of injury and actual injury status information.

The example threshold determiner 306 determines, based on the minimum and maximum probability information, a list or set of possible thresholds to organize the information. The threshold determiner 306 can generate a plurality of thresholds from the minimum probability to the maximum probability, for example. For example, the threshold determiner 306 creates an array of threshold values starting at the minimum probability (e.g., 0.0025, etc.) and determines incrementing threshold values by a threshold increment (e.g., 0.0025, etc.) until the maximum probability of injury is reached.

The example probability converter 308 receives the probability and threshold information and generates a percentage of injury with associated threshold information. For example, for each threshold, a compute probability of injury function is executed by passing the probability of injury, a threshold probability (e.g., 50, 60, 70, etc.), a maximum probability of injury (e.g., 80, 85, 90, etc.), a threshold tolerance (e.g., 0.01, 0.05, 0.1, etc.), maximum threshold probability (e.g., 0.3, 0.4, 0.5, etc.) as inputs to the function. The compute probability of injury function converts the probability of injury into a percentage of injury. To transform the probability of injury into a percentage, each threshold is converted with a tolerance (e.g., +/−0.05, etc.). The conversion and tolerance or range provides a minimum value and a maximum value for the threshold. Then, each probability of injury is checked for certain conditions with the minimum and maximum threshold values. A first condition applied by the probability converter 308 is that the probability of injury is within range of the minimum and maximum values of the threshold, for example. If the probability of injury is not within the determined minimum and maximum threshold values, then, the probability converter 308 applies a second condition to determine whether the probability of injury is less than the minimum value of the threshold. If the probability of injury is less than the minimum value of the threshold, then a slope m1 is calculated, and a prediction probability is determined by multiplying m1 with the probability of injury. If the probability of injury is not less than the minimum threshold value but is outside the range of the minimum and maximum threshold values, then the probability converter 308 applies a third condition to determine whether the probability of injury is greater than the maximum value of the threshold. If the probability of injury is greater than the maximum threshold value, then a slope m2 is calculated, and a prediction probability is determined by multiplying m2 with the probability of injury and adding the threshold probability value.

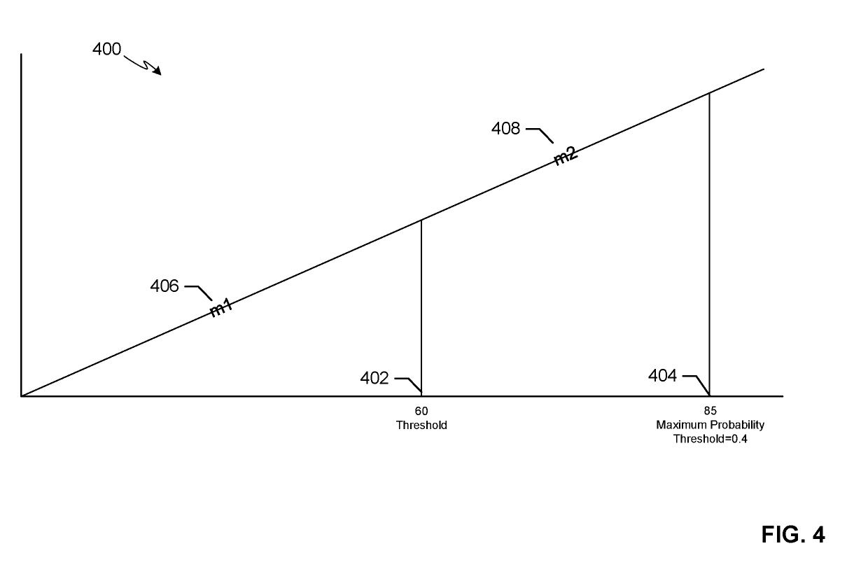

FIG. 4 illustrates an example m1, m2 determination 400 for a threshold probability of 60, a maximum probability of injury of 85, a threshold tolerance of 0.05, and a maximum threshold probability of 0.4. As shown in the example 400 of FIG. 4, the threshold 402 and the maximum probability threshold 0.4 are used to evaluate probabilities of injury. A slope m1 406 is determined based on a ratio or difference between threshold probability of injury and maximum probability of injury (x1, x2) with respect to threshold and maximum threshold probability values (y1, y2) for the first segment m1:

Slope m1=(x2−x1)/(y2−y1). Equation 1

In the example of FIG. 4, the slope m1 406 can be calculated according to an initial value 0 and a threshold 402 of 60 to be Slope m1=(60−0)/(threshold−0).

A slope m2 408 is determined based on a ratio or difference between the threshold probability of injury and the maximum probability of injury (e.g., 60 and 85 in the example of FIG. 4) with respect to the threshold and maximum threshold values (e.g., 0.4 and threshold 402 in the example of FIG. 4) for the second segment m2. Thus, in the example of FIG. 4, Slope m2=(85−60)/(0.4−threshold).

As discussed above, the example probability converter 308 generates a predicted probability of injury based on the determined threshold(s) by, with m1, multiplying m1 with the probability of injury. With m2, the example probability converter 308 generates the predicted probability of injury by multiplying m2 with the probability of injury and adding the threshold probability value. The predicted probability of injury is represented as a percentage of injury (e.g., a percentage of players probable to be injured, etc.).

The example band creator 310 distributes the percentage of injury into a plurality of bands with associated thresholds. The example probability converter 308 provides the determined percentage of injury to the band creator 310, which generates multiple bands (e.g., normal band, elevated band, significant band, low risk, medium risk, high risk, etc.) in which to distributed the percentage of injury.

For example, the band creator 310 may determine that a normal threshold is 55, an elevated threshold is 65, and a significant threshold is greater than 65. In this example, if the percentage of injury is between 0 and 55, then a normal injury total count is incremented by the band creator 310. If the actual injury information indicates an actual injury occurring at that probability, then a normal injury count is incremented as well. If the percentage of injury is between 55 to 65, then an elevated injury total count is incremented by the band creator, and, if an actual injury has occurred at that probability, then an elevated injury count is also increased. If the percentage of injury is more than 65, then a significant injury total count is incremented by the band creator, and, if the actual injury information indicates that an actual injury happened for that probability, then a significant injury count is also increased. After processing all probability of injury for each threshold, a percentage of injury that happened in each band is calculated by the band creator 310 by taking a ratio of injury count and total injury count of the corresponding band.

The example band evaluator 312 analyzes the bands determined by the band creator 310 as well as their associated thresholds in comparison to prior threshold values to determine optimal or improved threshold value(s). For each threshold, a difference between injury percentages in adjacent bands surrounding the threshold is calculated. For example, a percentage of significant injury and a percentage of elevated injury are determined by the band evaluator 312. The band evaluator 312 then evaluates the determined threshold value from the band creator 310 by comparing a first difference between adjacent bands divided by the determined threshold (e.g., between percentage of significant injury and percentage of elevated injury, etc.) to a second difference associated with a previous threshold (e.g., between percentage of significant injury and percentage of elevated injury, etc.). If the first difference is greater than the second difference, then the threshold value determined by the band creator 310 becomes the new/updated “optimal” or otherwise improved threshold value. Thus, after processing each threshold from the band creator 310, the band evaluator 312 provides optimal, improved, and/or otherwise desired threshold value(s) that maximize the difference in percentage of significant injury and percentage of elevated injury.

The example threshold output processor 314 receives and outputs the optimal, desired, and/or otherwise improved threshold value(s) such as for use by the report generator 108. The threshold output processor 314 can format, organize, and/or otherwise arrange the threshold value(s) (and associated band information) to be provided to the report generator 108 to be used by the report generator in generating reports and/or otherwise outputting alert(s) of player risk to a requesting party (e.g., a coach, a scheduling system, an agent, a forecasting system, etc.

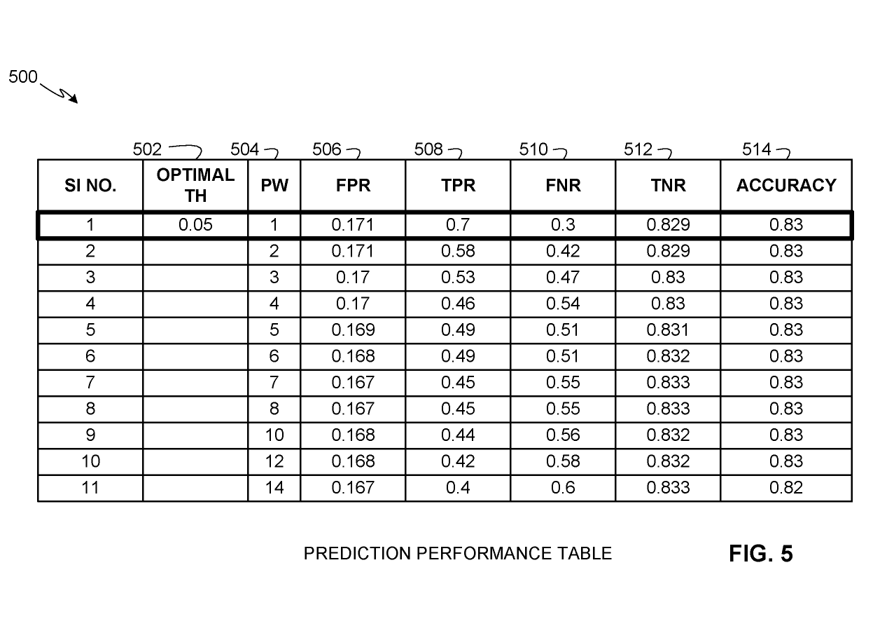

For example, FIG. 5 shows results of predictive analytics performed by the example apparatus 100 of FIGS. 1-3. In the illustrated example, a true-positive rate (TPR) of 70% was achieved using highly unbalanced data (e.g., 1.6% positive cases). FIG. 5 illustrates an example prediction performance table 500 showing accuracies of injury predictions generated by the example apparatus 100. In table 500, different sports injury prediction accuracies are shown in a number of rows for different prediction IDs (e.g., prediction IDs labeled as SI No. in FIG. 5). The example table 500 includes an example optimal threshold (TH) column 502, an example prediction window (PW) column 504, an example false-positive rate (FPR) column 506, an example true-positive rate (TPR) column 508, an example false-negative rate (FNR) column 510, an example true-negative rate (TNR) column 512, and an example accuracy column 514. The example optimal threshold column 502 includes thresholds that are used to designate the absence or presence of the future injury. For example, an optimal threshold of 0.05 indicates that a probability of injury less than 0.05 is indicative of no future injury, whereas a probability of injury equal to or greater than 0.05 is indicative of the occurrence of a future injury. The example PW column 504 includes prediction windows, which are day-range windows extending between the date a prediction is made and a target date of a game/competition. Different prediction windows may be based on the number of days (e.g., a days-range) before a target game/competition date that results in the most accurate predictions.

The example FPR column 506 includes numbers that represent false indicators of positive rates for propensities of injury. The example TPR column 508 includes numbers that represent true indicators of positive rates for propensities of injury. The example FNR column 510 includes numbers that represent false indicators of negative rates for propensities of injury. The example TNR column 512 includes numbers that represent true indicators of negative rates for propensities of injury. The example accuracy column 514 includes percentages of accuracies between predicted injuries and confirmed occurrences of injuries.

The example rates (FPR, TPR, FNR, TNR) shown in the table 500 of FIG. 5 are representative of ratios of cases when injuries were or were not predicted divided by cases when such predicted injuries did or did not occur. For example, an FPR is representative of a ratio of injuries that were predicted relative to actual non-occurrences of one or more of those injuries in a game/competition. A TPR is representative of a ratio of injuries that were predicted relative to actual occurrences of one or more of those injuries. An FNR is representative of a ratio of injuries not predicted relative to actual occurrences of one or more of those injuries. A TNR is representative of a ratio of injuries not predicted relative to actual non-occurrences of one or more of those injuries.

In the illustrated example of FIG. 5, TPR is very high (70%) with one day as a prediction window. In the example associative memory base 102 of FIG. 1, player injuries are not linked to corresponding games. As such, injuries reported within one day after a game date are considered to have occurred on that game date. In addition, validations of injury predictions show that injury predictions generated using a one day prediction window have a high level of accuracy. Also, FNR is lowest when the prediction window is between 1-3 days (30%-47%) before a target game/competition date. In addition, FPR is very good for all prediction windows (˜17%). The difference is not significant (e.g., the variation in FPR among different prediction windows shows a decrease from ˜19% (with all injuries) to ˜17%). In the illustrated example, the removal of contact injuries removed noise from data by increasing credibility of injury cases, hence increasing TPR and reducing FPR.

Examples disclosed herein were tested and proven on around 8000 game date and player combinations from an NBA sports database (e.g., the AMB 102 of FIG. 1). The disclosed example predictive framework predicted injuries in players based on top most similar players obtained following an all-but-one selection methodology. The disclosed examples predicted injuries of players with 83% accuracy in a wide range of prediction windows spanning 1-14 days.

Examples disclosed herein can be extended to include any number of similar athletes and different parameters from the AMB 102 for identifying similar athletes such as from opponent teams, etc. In addition, probability of injury calculations can be modulated to account for different time periods in a sport season. For example, injuries can be more likely during the latter part of a season.

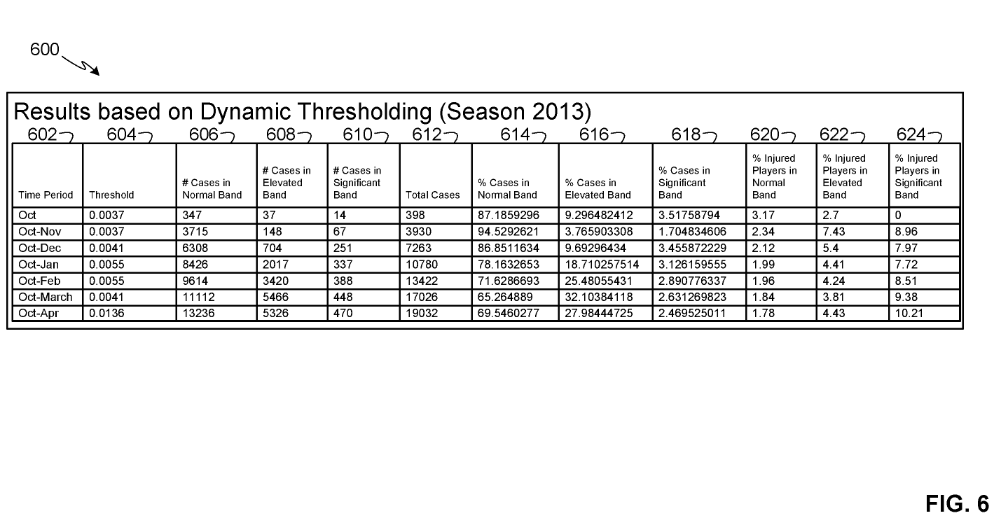

FIGS. 6-8 illustrate dynamic thresholding results 600, 700, 800 using three seasons of NBA data (2013, 2014, and 2015). As illustrated the example tables 600-800, a cost function defining a percentage of injured players in each category is maintained from the beginning of the season to the end of the season (November to April) for all three seasons. Thus, certain examples increase performance of injury prediction algorithm(s) and provide coverage for an entire season, rather than only a portion of the season. As shown in the example data, fixed thresholding met the cost function (percentage injured players in each category/band) only towards the end of the season, whereas the dynamic thresholding provided accuracy throughout the season.

For example, FIG. 6 shows results based on dynamic thresholding for the 2013 NBA season. The data in the example table 600 is organized according to time period 602, threshold 604, number of cases in the normal band 606, number of cases in the elevated band 608, number of cases in the significant band 610, total cases 612, percentage of cases in the normal band 614, percentage of cases in the elevated band 616, percentage of cases in the significant band 618, percentage of injured players in the normal band 620, percentage of injured players in the elevated band 622, and percentage of injured players in the significant band 624.

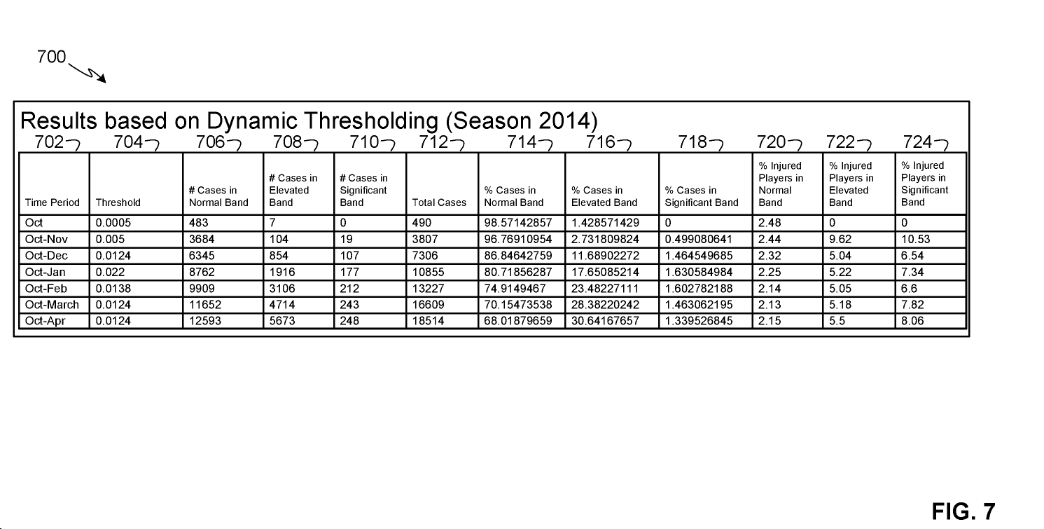

Similarly, for the 2014 season, data in the example table 700 of FIG. 7 is organized according to time period 702, threshold 704, number of cases in the normal band 706, number of cases in the elevated band 708, number of cases in the significant band 710, total cases 712, percentage of cases in the normal band 714, percentage of cases in the elevated band 716, percentage of cases in the significant band 718, percentage of injured players in the normal band 720, percentage of injured players in the elevated band 722, and percentage of injured players in the significant band 724.

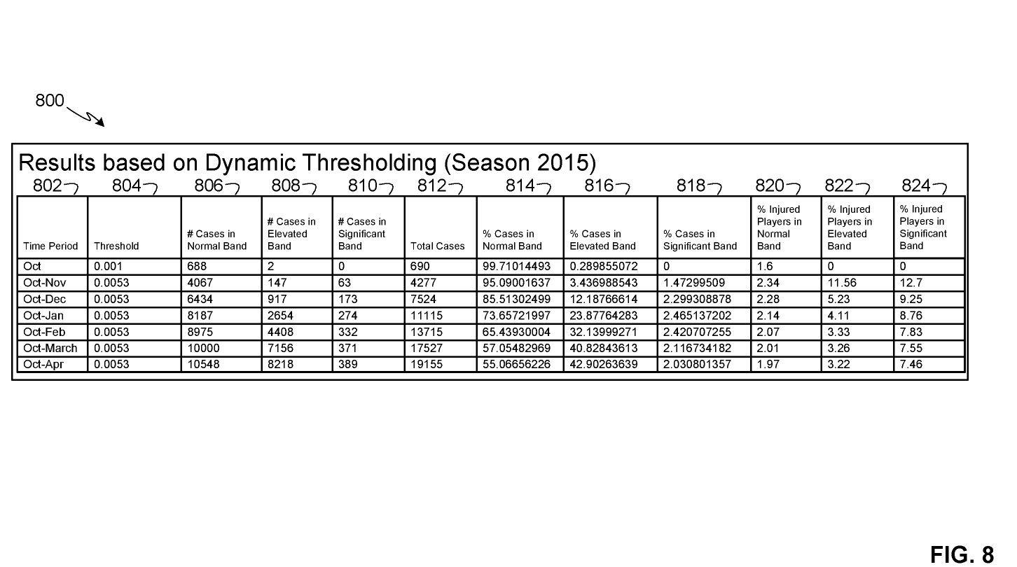

Data in the example table 800 of FIG. 8 is organized according to time period 802, threshold 804, number of cases in the normal band 806, number of cases in the elevated band 808, number of cases in the significant band 810, total cases 812, percentage of cases in the normal band 814, percentage of cases in the elevated band 816, percentage of cases in the significant band 818, percentage of injured players in the normal band 820, percentage of injured players in the elevated band 822, and percentage of injured players in the significant band 824. While example implementations of the system 100 are illustrated in FIGS. 1-3, one or more of the elements, processes and/or devices illustrated in FIGS. 1-3 can be combined, divided, re-arranged, omitted, eliminated and/or implemented in any other way. Further, the example associative memory base 102, the example data interface 104, the example predictor 106, the example report generator 108, the example validator 110, the example threshold generator 220, the example input processor 302, the example probability evaluator 304, the example threshold determiner 306, the example probability converter 308, the example band creator 310, the example band evaluator 312, the example threshold output processor 314, and/or, more generally, the example apparatus 100 of FIGS. 1-3 can be implemented by hardware, software, firmware and/or any combination of hardware, software and/or firmware. Thus, for example, any of the example associative memory base 102, the example data interface 104, the example predictor 106, the example report generator 108, the example validator 110, the example threshold generator 220, the example input processor 302, the example probability evaluator 304, the example threshold determiner 306, the example probability converter 308, the example band creator 310, the example band evaluator 312, the example threshold output processor 314, and/or, more generally, the example apparatus 100 of FIGS. 1-3 can be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example associative memory base 102, the example data interface 104, the example predictor 106, the example report generator 108, the example validator 110, the example threshold generator 220, the example input processor 302, the example probability evaluator 304, the example threshold determiner 306, the example probability converter 308, the example band creator 310, the example band evaluator 312, the example threshold output processor 314, and/or, more generally, the example apparatus 100 FIGS. 1-3 is/are hereby expressly defined to include a non-transitory computer readable storage device or storage disk such as a memory, a digital versatile disk (DVD), a compact disk (CD), a Blu-ray disk, etc. including the software and/or firmware. Further still, the example apparatus 100 of FIGS. 1-3 can include one or more elements, processes and/or devices in addition to, or instead of, those illustrated in FIGS. 1-3, and/or may include more than one of any or all of the illustrated elements, processes and devices.

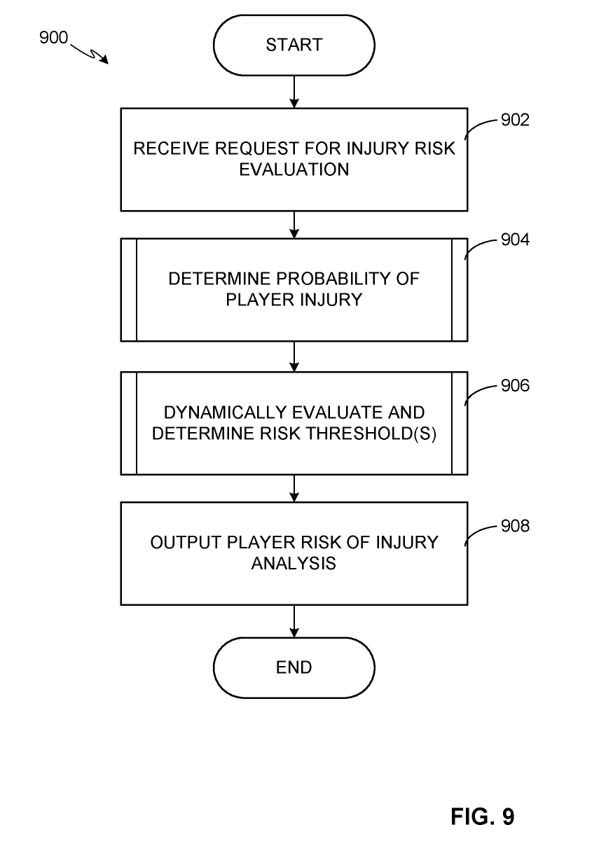

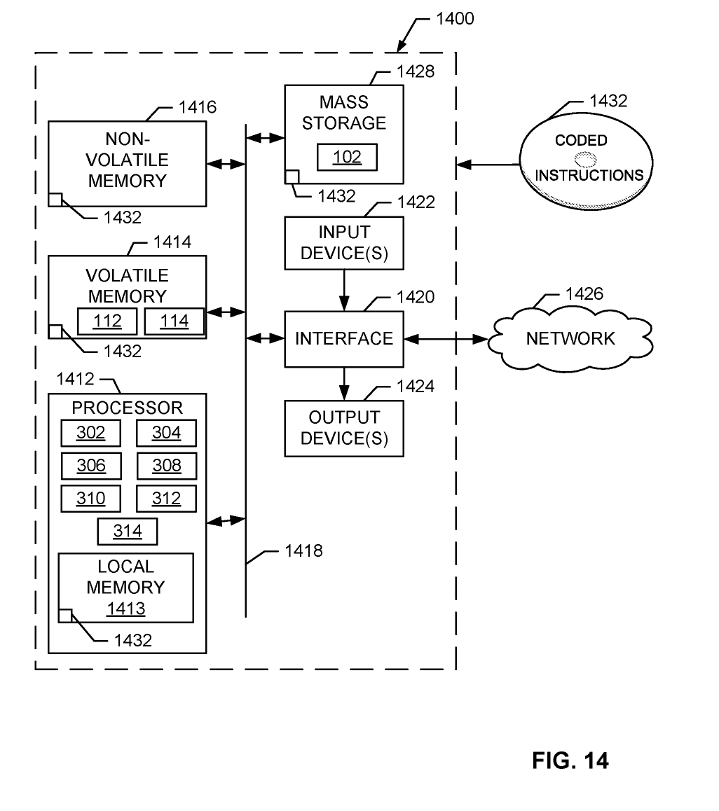

Flowcharts representative of example machine readable instructions for implementing the system 100 of FIGS. 1-3 are shown in FIGS. 9-13. In this example, the machine readable instructions include a process or program 900 for execution by a processor such as the processor 1412 shown in the example processor platform 1400 discussed below in connection with FIG. 14. The program 900 may be embodied in software stored on a non-transitory computer readable storage medium such as a CD-ROM, a floppy disk, a hard drive, a digital versatile disk (DVD), a Blu-ray disk, or a memory associated with the processor 1412, but the entire program 900 and/or parts thereof could alternatively be executed by a device other than the processor 1412 and/or embodied in firmware or dedicated hardware. Further, although the example program 900 is described with reference to the flowcharts illustrated in FIGS. 9-13, many other methods of implementing the example apparatus 100 can alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, a Field Programmable Gate Array (FPGA), an Application Specific Integrated circuit (ASIC), a comparator, an operational-amplifier (op-amp), a logic circuit, etc.) structured to perform the corresponding operation without executing software or firmware.

As mentioned above, the example program 900 of FIGS. 9-13 can be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. “Including” and “comprising” (and all forms and tenses thereof) are used herein to be open ended terms. Thus, whenever a claim lists anything following any form of “include” or “comprise” (e.g., comprises, includes, comprising, including, etc.), it is to be understood that additional elements, terms, etc. may be present without falling outside the scope of the corresponding claim. As used herein, when the phrase “at least” is used as the transition term in a preamble of a claim, it is open-ended in the same manner as the term “comprising” and “including” are open ended.

The program 900 of FIG. 9 begins with receiving a request for evaluation of a player's probability of injury (block 902). For example, a user, a program, a device, etc., can submit and/or otherwise trigger an analysis of a player's likelihood of injury. At block 904, a probability of player injury is determined. For example, probabilities of sports and/or other injuries can be predicted and/or validated as described above. At block 906, thresholds between categories or bands of player injury probabilities are dynamically evaluated and determined. For example, as more data is gathered, the injury probability data and distribution of the injury probability data are re-evaluated to determine whether threshold(s) separating probabilities and associated players into different bands (e.g., significant risk of injury, elevated risk of injury, normal risk of injury, etc.) should be updated. By updated thresholds and, thereby, recategorizing player injury risk, a distribution of risk across categories/types/bands/etc., can be adjusted, held consistent over time, and/or otherwise regulated for more effective, informative, and productive player injury prediction and analysis, for example.

At block 908, a player's risk of injury is output. For example, a report can be generated describing a probability and/or other risk of injury for one or more players on a team. The risk of injury can be quantified as a percentage or likelihood value and/or qualified as a type or category of risk such as high risk, low risk, medium risk and/or normal risk, elevated risk, significant risk, etc. In some examples, criteria and/or explanation for divisions of risk among bands based on thresholds can be provided with the player risk estimation.

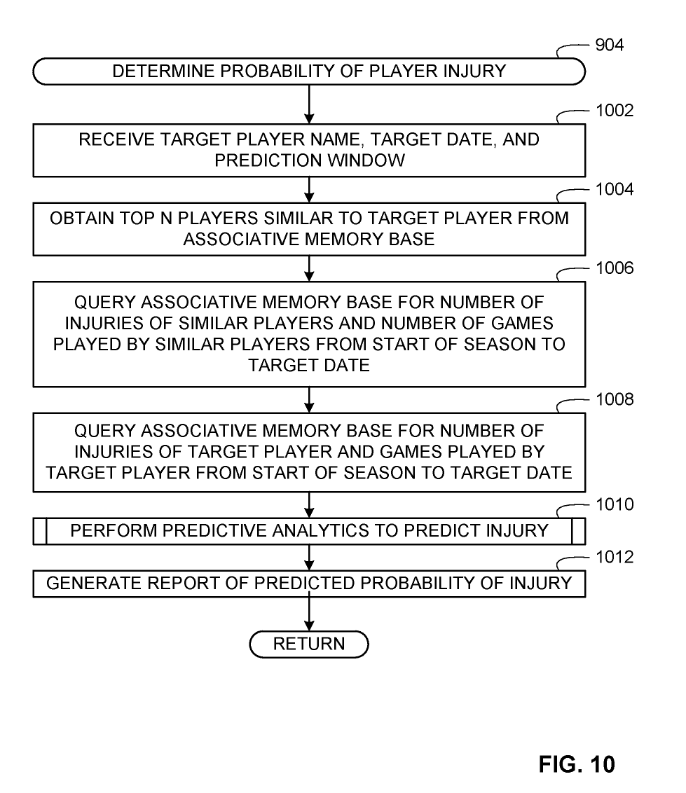

FIG. 10 is a flow diagram representative of example machine readable instructions that may be executed by a processor (e.g., the example processor 1412 of FIG. 14) to predict probabilities of sports injuries (e.g., block 904 of the example of FIG. 9). In the example process of FIG. 10, the example predictor 106 of FIGS. 1-2 predicts injuries of target participants for target dates (e.g., target game dates, target competition dates, etc.) based on predictive analytics of performance data collected for a current sport's season (e.g., from a start of the sport's season to a target date) based on a received target player name, a target date, and a prediction window (block 1002). The example data interface 104 obtains the top N players similar to the target player from the AMB 102 (block 1004). For example, the data interface 104 queries the AMB 102 (e.g., using JavaScript, python, etc.) to find the top N players that are most similar to the target player. In the illustrated example, the AMB 102 can use a priority ranking of the similar players using a Kolmogorov complexity metric based on similarities in cumulative values of performance data parameters over the last 7, 14, and 21 days within a sport's season before a target date. Thus, at block 1004, the data interface 104 can receive from the AMB 102 the player IDs of the selected top N players having more similarities with the target player based on the performance data parameters than other players in the AMB 102. The periodic intervals of 7, 14, and 21 days for which to access performance data are examples that may be selected to increase the accuracies of injury predictions for subsequent games. Any other suitable intervals may be used based on desired levels of accuracy and available data to suit the needs of particular implementations. In the illustrated example, the selecting of the top N similar players is based on a priority ranking of performance data parameters. An example two-level priority ranking of performance data parameters that may be employed for selecting the top N similar players at block 1004 is provided as follows in association with performance data parameters (a)-(g), is: (a) physiological load (physio_load) (priority level 1), (b) mechanical load (mechanical_load) (priority level 1), (c) mechanical intensity (mechanical_intensity) (priority level 2), (d) physical intensity (physical_intensity) (priority level 1), (e) number of games played (games_played) (priority level 1), (f) average running seconds (avg_seconds) (priority level 1), and (g) average field goals (avg_field_goals) (priority level 1). In some examples, fewer, more, and/or other performance data parameters may be employed. In addition, any number of priority levels may be employed, and the priority order of the performance data parameters may be changed.

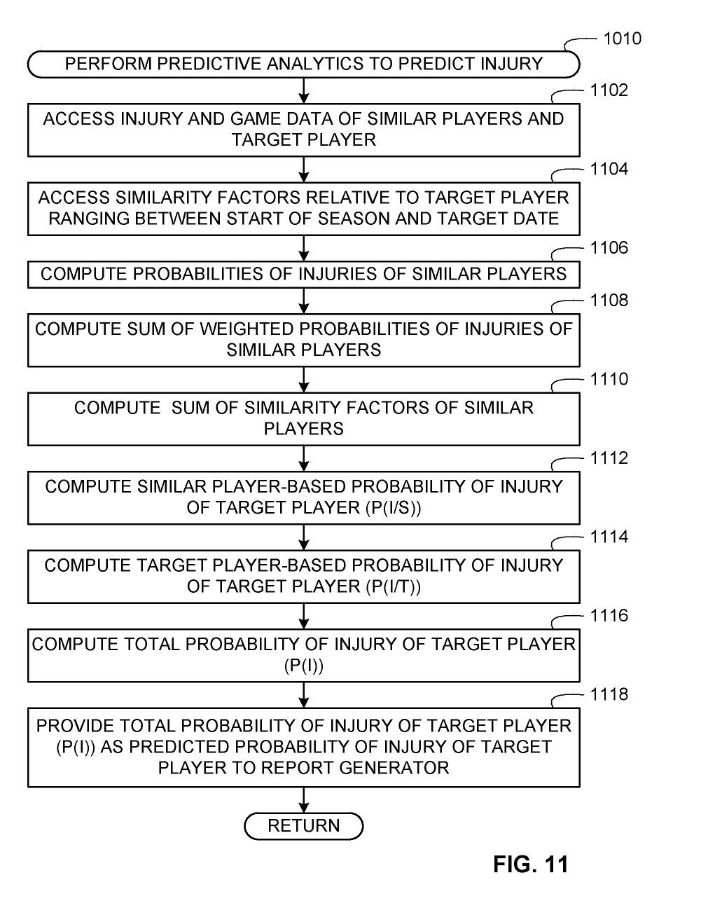

The example data interface 104 queries the AMB 102 for the number of injuries of the similar players and the number of games played by the similar players from the start of a season to the target date (block 1006). The example data interface 104 queries the AMB 102 for the number of injuries of the target player and the number of games played by the target player from the start of the season to the target date (block 1008). The example predictor 106 (FIGS. 1-2) performs predictive analytics on the obtained data to predict an injury of the target player (block 1010). An example process that may be used to implement the predictive analytics of block 1010 is described below in connection with the flow diagram of FIG. 11. The example report generator 108 (FIGS. 1-2) generates a report of the predicted probability of injury of the target player on the target date (block 1012). For example, the report generator 108 can generate the injury prediction report 112 of FIGS. 1 and 5. The example process of FIG. 9 then ends, and control is passed back to a calling function or process such as the example process of FIG. 9.

FIG. 11 is a flow diagram representative of example machine readable instructions that may be executed by a processor (e.g., the example processor 1412 of FIG. 14) to perform a predictive analytics process to predict probabilities of sports injuries (e.g., block 1010 of the example of FIG. 10). The predictive analysis of FIG. 11 computes the probability of injury of similar players (P(S)) weighted with similarity factors (M) with respect to the target player. The sum of these weighted probabilities normalized with the sum of the similarity factors (M) provides a similar player-based probability of injury of the target player (e.g., a probability of injury for the target player based on performance data of the similar players which represented by the notation P(I/S)). For example, if the probability of injury of all similar players is one, then the similar player-based probability of injury of the target player (P(I/S)) would be one, and if the probability of injury of all similar players is zero, the similar player-based probability of injury of the target player (P(I/S)) would also be zero. For all other values, the similar player-based probability of injury of the target player (P(I/S)) would be between 0 and 1.

Research conducted in the development of techniques disclosed herein shows that a previous injury is a good predictor of injury. Hence, the predictive analysis disclosed herein also computes the injury trend of the target player and computes the total probability of injury of the target player (P(I)) (e.g., the predicted probability of injury of the target player) based on a combination of the similar player-based probability of injury of the target player (P(I/S)) (e.g., a probability of injury of the target player based on performance data of the similar players) and a target player-based probability of injury of the target player (P(I/T)) (e.g., a probability of injury of the target player based on performance data of the target player).

Initially, in the example process 1010 of FIG. 11, the example predictor 106 accesses injury and game data of similar players and the target player (block 1102). For example, the predictor 106 accesses injury and game data of similar players and the target player from a start of a current season to a target date. The example predictor 106 also accesses similarity factors (M) relative to the target player ranging between the start of the season and the target date (block 1104). The example predictor 106 computes the probabilities of injuries of the similar players (block 1106). In the illustrated example, the predictor 106 determines a probability of injury for each similar player (P(S)) based on the number of games played and the number of injuries of that corresponding similar player between the start of the sport's season and the target date. For example, the predictor 106 determines the probability of injury of a similar player (P(S)) by dividing a number of injuries of the similar player by the number of games played by the similar player (e.g., P(S)=number of injuries of similar player/number of games played by the similar player). In this manner, for each similar player, the example predictor 106 determines an average number of injuries per game that can be used as the probability of that similar player getting injured (P(S)) in a next game.

The example predictor 106 computes the sum of weighted probabilities of injuries of the similar players (P(S)M) (block 1108). For example, the predictor 106 computes the sum of weighted probabilities of injuries of the similar players (P(S)M) by multiplying each probability of injury of each similar player (P(S)) determined at block 1106 by a corresponding similarity factor (M) of that similar player, and summing the weighted probabilities of injuries of the similar players (P(S)M). In the illustrated example, the predictor 106 uses Equation 2 below to compute the sum of weighted probabilities of injuries of the similar players (P(S)M) of block 1108:

P(S)M=Σ_{(i=1:N)}(P(S(i))*M(i). Equation 1

In example Equation 2 above, the sum of weighted probabilities of injuries of the similar players (P(S)M) is determined based on the probability of injury of each similar player (P(S(i))) and the similarity factor (M(i)) for that similar player for a number of i=N similar players. That is, the sum of weighted probabilities of injuries of the similar players (P(S)M) is determined as a sum of the products of: (1) the probability of injury of each similar player (P(S)) and (2) the similarity factor (M) of that similar player. The probability of injury of each similar player (P(S(i))) used in example Equation 2 above is determined at block 1106 for the current sport's season. By using example Equation 2, the probability of injury of each similar player (P(S)) is weighted by the corresponding similarity factor (M) for that similar player so that each probability of injury of a similar player (P(S)) can be used as a component in determining the probability of injury of a target player based on the similarity (e.g., the weighting by the similarity factor (M)) between that similar player and the target player.

The example predictor 106 computes the sum of the similarity factors of the similar players (block 1110). In the illustrated example, the predictor 106 determines the sum of the similarity factors (M) of the similar players using Equation 3 below.

Sum of the similarity factors (M)=Σ_{(i=1:N)}M(i). Equation 3

In Equation 3 above, the sum of the similarity factors (M) of the similar players is a summation of the similarity factors (M(i)) for a number of i=N similar players. For example, the sum of the similarity factors (M) of the similar players is a sum of percentages representative of amounts of similarity between performance data parameters of a similar player for a current sport's season and performance data parameters of a target player. The percentages can be based on a Kolmogorov Complexity analysis of (e.g., distances between player attributes).

The example predictor 106 computes a similar player-based probability of injury of the target player (P(I/S)) (block 1112). In the illustrated example, the predictor 106 computes a similar player-based probability of injury of the target player (P(I/S)) using Equation 4 below.

$$P ( I \text{/} S ) = \frac{{\sum }_{( i = 1 : N )}^{ } ( P ( S ( i ) ) ) * M ( i )}{{\sum }_{( i = 1 : N )}^{ } M ( i )} . \qquad Equation 4$$

In example Equation 4 above, the similar player-based probability of injury of the target player (P(I/S)) is determined by dividing the sum of weighted probabilities of injuries of the similar players (e.g., Σ_{(i=1:N}(P(S(i))*M(i)) determined at block 1108 above by the sum of the similarity factors of the similar players (Σ_{(i=1:N)}M(i)) determined at block 1110 above (e.g., P(I/S)=(sum of the weighted probabilities of injuries of the similar players from start of season to target date)/(sum of the similarity factors of the similar players)). In some examples, the example predictor 106 predicts the similar player-based probability of injury of the target player at block 1112 by treating the target player like a representative similar player based on the collective similar players (e.g., a virtual player that is similar to or representative of the collective similar players) as a result of the operation of block 1112 being based on characteristics of the similar players (e.g., the injury and game data of each similar player accessed at block 1102, and the similarity factors of the similar players accessed at block 1104). In such examples, the similar player-based probability of injury for a representative similar player is used as the similar player-based probability of injury for the target player.

The example predictor 106 computes a target player-based probability of injury of the target player (P(I/T)) (block 1114). For example, the predictor 106 determines the target player-based probability of injury of the target player (P(I/T)) by dividing the number of injuries of the target player by the number of games played by the target player from the start of the season to the target date (e.g., (P(I/T))=(number of injuries of the target player from the start of the season to the target date)/(number of games played by the target player from the start of the season to the target date)). The example predictor 106 computes the total probability of injury of the target player (P(I)) (block 1116). In the illustrated example, the predictor 106 determines the total probability of injury of the target player (P(I)) based on a combination of the similar player-based probability of injury for the target player (P(I/S)) and the target player-based probability of injury of the target player (P(I/T)). For example, a linear combination of the similar player-based probability of injury for the target player (P(I/S)) and the target player-based probability of injury of the target player (P(I/T)) may be determined by determining the sum of P(I/S) and P(I/T), and dividing the sum by two (i.e., Linear Combination=(P(I/S)+P(I/T))/2). In other examples, nonlinear combinations of the similar player-based probability of injury for the target player (P(I/S)) and the target player-based probability of injury of the target player (P(I/T)) may additionally or alternatively be employed to determine the total probability of injury of the target player (P(I)) at block 1116. For example, a nonlinear combination may be used by determining a square root (or any root) of the similar player-based probability of injury for the target player (P(I/S)) and adding the result to the target player-based probability of injury of the target player (P(I/T)). In yet other examples, other techniques for determining a combination of the probability of injury for the target player based on the similar players (P(I/S)) and the probability of injury of the target player (P(I/T)) may be employed at block 1116. In the illustrated example, the predictor 106 provides the total probability of injury of the target player (P(I)) as the predicted probability of injury of the target player to the report generator 108 (block 1118). Thus, the example report generator 108 can generate the prediction report 112 (FIG. 1) at block 1012 of FIG. 10 to include the total probability of injury of the target player determined at block 1116 as the predicted probability of injury of the target player for the target date. The example process of FIG. 11 then ends, and control is passed back to a calling function or process such as the example process of FIG. 10.

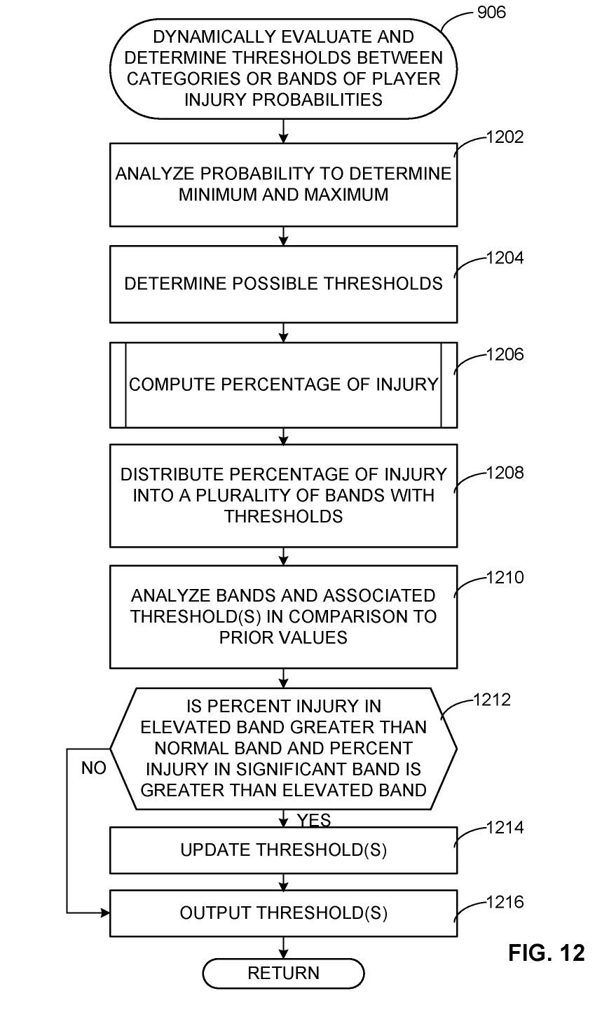

FIG. 12 is a flow diagram representative of example machine readable instructions that may be executed by a processor (e.g., the example processor 1412 of FIG. 14) to dynamically evaluate and determine thresholds between categories or bands of player injury probabilities (e.g., block 906 of the example of FIG. 9). The example process 906 of FIG. 9 can be repeated for a plurality of probabilities, players, etc. In the example process of FIG. 12, a probability of injury is analyzed to determine a minimum probability of injury and a maximum probability of injury from an array of probability of injuries provided by block 904 of the example of FIG. 9 (block 1202).

For example, the example input processor 302 receives an input including probability of injury and actual injury status information. The example probability evaluator 304 evaluates the probability information to determine minimum and maximum probability. For example, a first input of a probability of injury can be calculated for both a target player and a similar player, and an average of the two probabilities can be calculated. A second input is “ground truth” that indicates a player's actual injury status which shows that either the player is actually injured or is not. The example probability evaluator 304 evaluates the probability information to determine minimum and maximum probability from an array of injury probabilities based on the input probability of injury and actual injury status information.

At block 1204, possible thresholds to organize the injury risk information are determined based on the minimum and maximum probability information. For example, the threshold determiner 306 generates a plurality of thresholds from the minimum probability to the maximum probability. For example, the threshold determiner 306 creates an array of threshold values starting at the minimum probability (e.g., 0.0025, etc.) and determines incrementing threshold values by a threshold increment (e.g., 0.0025, etc.) until the maximum probability of injury is reached.

At block 1206, a percentage of injury is computed with associated threshold information. For example, the probability converter 308 receives probability and threshold information and generates a percentage of injury with associated threshold information.

For example, for each threshold, a compute probability of injury function is executed by passing the probability of injury, a threshold probability (e.g., 50, 60, 70, etc.), a maximum probability of injury (e.g., 80, 85, 90, etc.), a threshold tolerance (e.g., 0.01, 0.05, 0.1, etc.), maximum threshold probability (e.g., 0.3, 0.4, 0.5, etc.) as inputs to the function. The compute probability of injury function converts the probability of injury into a percentage of injury. To transform the probability of injury into a percentage, each threshold is converted with a tolerance (e.g., +/−0.05, etc.). The conversion and tolerance or range provides a minimum value and a maximum value for the threshold. Then, each probability of injury is checked for certain conditions with the minimum and maximum threshold values. A first condition applied by the probability converter 308 is that the probability of injury is within range of the minimum and maximum values of the threshold, for example. If the probability of injury is not within the determined minimum and maximum threshold values, then, the probability converter 308 applies a second condition to determine whether the probability of injury is less than the minimum value of the threshold. If the probability of injury is less than the minimum value of the threshold, then a slope m1 is calculated using Equation 1, and a prediction probability is determined by multiplying m1 with the probability of injury. If the probability of injury is not less than the minimum threshold value but is outside the range of the minimum and maximum threshold values, then the probability converter 308 applies a third condition to determine whether the probability of injury is greater than the maximum value of the threshold. If the probability of injury is greater than the maximum threshold value, then a slope m2 is calculated using Equation 1, and a prediction probability is determined by multiplying m2 with the probability of injury and adding the threshold probability value.

As discussed above, the example probability converter 308 generates a predicted probability of injury based on the determined threshold(s) by, with m1, multiplying m1 with the probability of injury. With m2, the example probability converter 308 generates the predicted probability of injury by multiplying m2 with the probability of injury and adding the threshold probability value. The predicted probability of injury is represented as a percentage of injury (e.g., a percentage of players probable to be injured, etc.).

At block 1208, the percentage of injury is distributed into a plurality of bands with associated thresholds. For example, the example band creator 310 distributes the percentage of injury into a plurality of bands with associated thresholds. The example probability converter 308 provides the determined percentage of injury to the band creator 310, which generates multiple bands (e.g., normal band, elevated band, significant band, low risk, medium risk, high risk, etc.) in which to distributed the percentage of injury. The band creator 310 can calculate a percentage represented in each band according to the following equation, for example:

Band %=Actual Injury of Band/Total Injury of Band. Equation 5

For example, the band creator 310 may determine that a normal threshold is 55, an elevated threshold is 65, and a significant threshold is greater than 65. In this example, if the percentage of injury is between 0 and 55, then a normal injury total count is incremented by the band creator 310. If the actual injury information indicates an actual injury occurring at that probability, then a normal injury count is incremented as well. If the percentage of injury is between 55 to 65, then an elevated injury total count is incremented by the band creator, and, if an actual injury has occurred at that probability, then an elevated injury count is also increased. If the percentage of injury is more than 65, then a significant injury total count is incremented by the band creator, and, if the actual injury information indicates that an actual injury happened for that probability, then a significant injury count is also increased. After processing all probability of injury for each threshold, a percentage of injury that happened in each band is calculated by the band creator 310 by taking a ratio of injury count and total injury count of the corresponding band according to Equation 5.

At block 1210, the updated bands and associated thresholds are compared to the prior bands and associated thresholds. For example, the example band evaluator 312 analyzes the bands and associated thresholds in comparison to the prior or preset threshold values to determine optimal or improved threshold value(s). The example band evaluator 312 analyzes the bands determined by the band creator 310 as well as their associated thresholds in comparison to prior threshold values to determine optimal or improved threshold value(s). For each threshold, a difference between injury percentages in adjacent bands surrounding the threshold is calculated. For example, a percentage of significant injury and a percentage of elevated injury are determined by the band evaluator 312. The band evaluator 312 then evaluates the determined threshold value from the band creator 310 by comparing a first difference between adjacent bands divided by the determined threshold (e.g., between percentage of significant injury and percentage of elevated injury, etc.) to a second difference associated with a previous threshold (e.g., between percentage of significant injury and percentage of elevated injury, etc.).

At block 1212, if the percentage injury in the elevated band is great than the percentage injury in the normal band and the percentage injury in the significant band is greater than the percentage injury in the elevated band, then the threshold value determined by the band creator 310 becomes the new/updated “optimal” or otherwise improved threshold value. Thus, after processing each threshold from the band creator 310, the band evaluator 312 provides optimal, improved, and/or otherwise desired threshold value(s) that maximize the difference in percentage of significant injury and percentage of elevated injury.

At block 1214, the updated threshold value(s) are output for use. For example, the example threshold output processor 314 outputs the optimal and/or otherwise improved threshold value(s) such as for use by the report generator 108. The threshold output processor 314 can format, organize, and/or otherwise arrange the threshold value(s) (and associated band information) to be provided to the report generator 108 to be used by the report generator in generating reports and/or otherwise outputting alert(s) of player risk to a requesting party (e.g., a coach, a scheduling system, an agent, a forecasting system, etc.

The example process of FIG. 12 then ends, and control is passed back to a calling function or process such as the example process of FIG. 9.

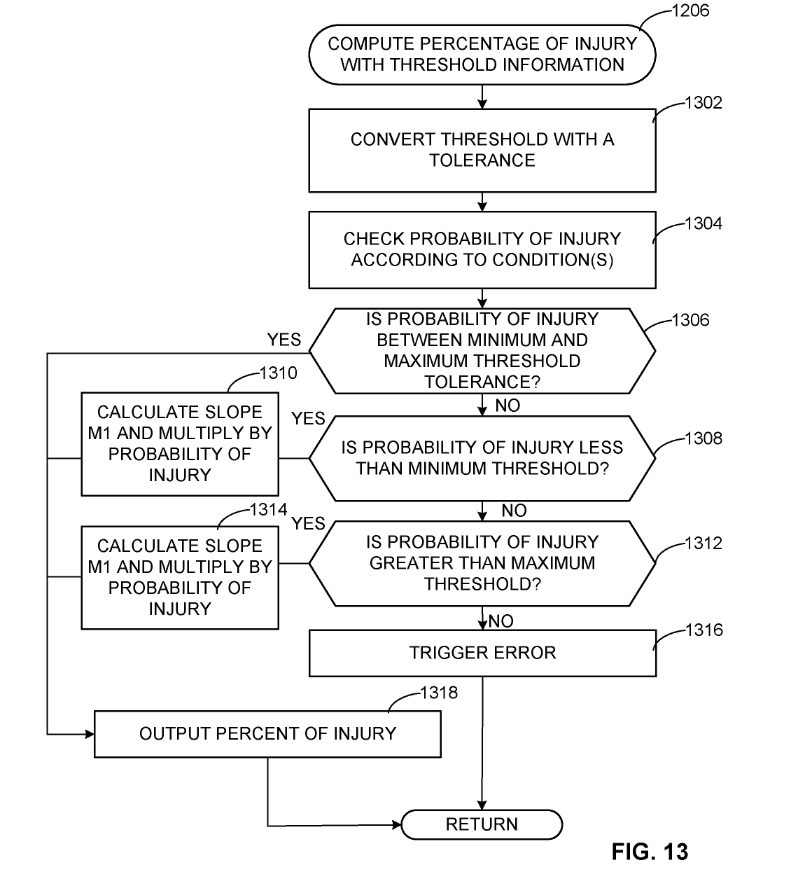

FIG. 13 is a flow diagram representative of example machine readable instructions that may be executed by a processor (e.g., the example processor 1412 of FIG. 14) to compute a percentage of injury with associated threshold information (e.g., block 1206 of the example of FIG. 12). For example, the probability converter 308 receives probability and threshold information and generates a percentage of injury with associated threshold information.

In the example process of FIG. 13, each threshold is converted with a tolerance (e.g., +/−0.05, etc.) (block 1302). The conversion and tolerance or range provides a minimum value and a maximum value for the threshold. Then, at block 1304, each probability of injury is checked for certain conditions with the minimum and maximum threshold values.

A first condition applied by the probability converter 308 is to evaluate whether the probability of injury is within range of the minimum and maximum values of the threshold (block 1306). If so, then the probability or percent of injury can be output. However, if the probability of injury is not within the determined minimum and maximum threshold values, then, at block 1308, a second condition is used by the probability converter 308 to determine whether the probability of injury is less than the minimum value of the threshold. If the probability of injury is less than the minimum value of the threshold, then, at block 1310, a slope m1 is calculated using Equation 1, and a prediction probability is determined by multiplying m1 with the probability of injury.

However, if the probability of injury is not less than the minimum threshold value, then, at block 1312, a third condition is used by the probability converter 308 to determine whether the probability of injury is greater than the maximum value of the threshold. If the probability of injury is greater than the maximum threshold value, then, at block 1314, a slope m2 is calculated using Equation 1, and a prediction probability is determined by multiplying m2 with the probability of injury and adding the threshold probability value.

Otherwise, an error has occurred and, at block 1316, an error is triggered (e.g., an alert, an alarm, a log entry, etc.). At block 1318, the percent of injury from block 1306, 1310, and/or 1314 is output. The example process of FIG. 13 then ends, and control is passed back to a calling function or process such as the example process of FIG. 12.

Thus, certain examples facilitate adaptive determination of appropriate threshold(s) to divide probability of injury information into a plurality of categories of bands. Rather than being limited by preset, static thresholds, certain examples provide technological improvement in data analytics, computer processing, and personnel monitoring to dynamically adapt to a richer data set representing evolving conditions through generation, evaluation, and implementation of updated threshold(s) based on a comparison of prior information, current information, limits, and truthed actual information versus predictive information. Certain examples facilitate consistent, valid categorization throughout an entire season and across multiple seasons through the adaptive thresholds adjusting which percentages are in which bands. Certain examples introduce new technology to generate line slopes and compute percentages and band comparisons to output updated threshold, band, and category/likelihood of risk information.

FIG. 14 is a block diagram of an example processor platform 1400 capable of executing the instructions of FIGS. 9-13 to implement the example apparatus 100 of FIGS. 1-3. The processor platform 1400 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 1400 of the illustrated example includes a processor 1412. The processor 1412 of the illustrated example is hardware. For example, the processor 1412 can be implemented by one or more integrated circuits, logic circuits, microprocessors or controllers from any desired family or manufacturer. In the illustrated example, the processor 1412 implements the example data interface 104, the example predictor 106, the example report generator 108, and the example validator 110, the example threshold generator 220, the example input processor 302, the example probability evaluator 304, the example threshold determiner 306, the example probability converter 308, the example band creator 310, the example band evaluator 312, and/or the example threshold output processor 314 of FIGS. 1-3.

The processor 1412 of the illustrated example includes a local memory 1413 (e.g., a cache). The processor 1412 of the illustrated example is in communication with a main memory including a volatile memory 1414 and a non-volatile memory 1416 via a bus 1418. The volatile memory 1414 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1416 may be implemented by flash memory and/or any other desired type of memory device. Access to the main memory 1414, 1416 is controlled by a memory controller. In the illustrated example, the volatile memory 914 is shown as storing the prediction report(s) 112 and the accuracy report(s) 114 of FIGS. 1-2. The reports 112 and/or 114 may additionally or alternatively be stored on any other memory in or external from the processor platform 1400.

The processor platform 1400 of the illustrated example also includes an interface circuit 1420. The interface circuit 1420 may be implemented by any type of interface standard, such as an Ethernet interface, a universal serial bus (USB), and/or a PCI express interface.

In the illustrated example, one or more input devices 1422 are connected to the interface circuit 1420. The input device(s) 1422 permit(s) a user to enter data and commands into the processor 1412. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1424 are also connected to the interface circuit 1420 of the illustrated example. The output devices 1424 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 1420 of the illustrated example, thus, typically includes a graphics driver card, a graphics driver chip or a graphics driver processor.

The interface circuit 1420 of the illustrated example also includes a communication device such as a transmitter, a receiver, a transceiver, a modem and/or network interface card to facilitate exchange of data with external machines (e.g., computing devices of any kind) via a network 1426 (e.g., an Ethernet connection, a digital subscriber line (DSL), a telephone line, coaxial cable, a cellular telephone system, etc.).

The processor platform 1400 of the illustrated example also includes one or more mass storage devices 1428 for storing software and/or data. Examples of such mass storage devices 1428 include floppy disk drives, hard drive disks, compact disk drives, Blu-ray disk drives, RAID systems, and digital versatile disk (DVD) drives. In the illustrated example, the mass storage device 928 is shown storing the AMB 102 of FIGS. 1-2. In other examples, the AMB 102 may be additionally or alternatively stored on any other memory in or external from the processor platform 1400.

Coded instructions 1432 used to implement the machine readable instructions of FIGS. 9-13 may be stored in the mass storage device 1428, in the volatile memory 1414, in the non-volatile memory 1416, and/or on a removable tangible computer readable storage medium such as a CD or DVD.

From the foregoing, it will be appreciated that the above-disclosed methods, apparatus, and articles of manufacture improve capabilities of a processor platform to more accurately predict likelihoods or probabilities of injuries of players/participants in sporting events. For example, techniques disclosed herein include a cognitive framework that may be implemented on a processor platform to perform predictive analysis of performance data for sports players accessible from an associative database to predict the probability of injury of a target player on a target date. In some professional or collegiate sports leagues (e.g., basketball, baseball, American football, soccer/(international futbol), lacrosse, rugby, cricket, volleyball, swimming, tennis, track and field, etc.), the numbers of teams and players is so overwhelmingly large that it is difficult or impossible to meaningfully and usefully track and analyze player performance data to accurately predict injuries of players in a timely manner. For example, during a sport's season, games/competitions are so numerous and frequent that any attempt to analyze the voluminous amounts of player performance data to predict a player injury for any approaching game/competition date could take such an unpractically long time that the game/competition date would pass before arriving at such a player injury prediction. Examples disclosed herein employ processor platforms for performing predictive analysis of such voluminous amounts of player performance data to predict a probability of injury of a target player in a timely manner before a next target game/competition date at any point in a season. For example, techniques disclosed herein can be employed the day before or even the day of a target game/competition date to predict the probability of injury of the target player before the game/competition begins. Techniques disclosed herein are applicable and effective in the first month of the season as well as the last month of the season. In some examples, predictive analysis techniques disclosed herein may be used to determine a probability of injury of a target player within minutes or seconds. The systems and methods disclosed herein enable dynamic, real-time (or substantially real-time) determination of thresholds dividing injury risk bands/categories to maintain injury risk distribution and draw distinctions between degrees of injury risk (e.g., normal, elevated, significant, etc.) providing more usable and actionable information to users (e.g., applications, devices, coaches, players, agents, etc.). Due to the voluminous amounts of data needed to be analyzed to perform the predictive analyses disclosed herein, such fast predictive analyses would not be possible without using techniques disclosed herein to improve the data analysis and computation functions of a processor system. In some examples, techniques disclosed herein may be implemented using multi-core processor systems, multi-processor systems, and/or distributed processing to increases speeds of the predictive analyses.

Examples disclosed herein are better than prior solutions for a number of reasons. For example, the predictive analytics disclosed herein are based on performance and fitness records of similar players stored and updateable in real time in an associative memory database. As such, the predictive analyses disclosed herein are can be performed in real time on the most up-to-date player performance and fitness data. In addition, the predictive analyses disclosed herein are adaptive because they do not require any offline or prior training on annotated data, unlike prior methods based on traditional machine learning techniques. In addition, examples disclosed herein do not rely on a pre-learned model. Thus, the disclosed techniques are highly flexible in many respects including the ability to add or remove attributes (e.g., performance data parameters). change similarity measuring parameters (e.g., performance data parameters on which similarity factors of the similar players are based), adjust thresholds assigning a player to one risk category or another, etc.

Also, since examples disclosed herein are not based on traditional classification methods, they provide a comparatively much better performance under unbalanced or spare data. For example, the techniques disclosed herein provide a 70% true positive rate with just 1.6% positive samples in the data. They also perform as accurately and consistently from the start of the season to the end of the season.

In addition, unlike model-based methods, techniques disclosed herein are not only based on injury data distributions of similar players, but also take into consideration injury histories of target players, which increases the accuracies of injury predictions. For example, techniques disclosed herein have been observed to achieve 80% prediction accuracy in predicting injuries for NBA players based on sports data (e.g., player performance data) provided by Kinduct Technologies.

Furthermore, examples disclosed herein leverage a rich sports database (e.g., an associative memory database) that is updated frequently with new data. As such, accuracies of predictions determined using examples disclosed herein improve over time, as more records are added, without any additional effort or human intervention, as there is no need to re-train or update the predictive analytics processes disclosed herein.

Rather than a probability of injury in a fixed band, certain examples provide dynamic bands/categories formed by dynamically adjusted analytics thresholds to react to a distribution of injury that varies throughout the season. When a request for information is recited, the threshold(s) is dynamically computed to take in account the current data set and to maintain the overall distribution of bands (e.g., low versus medium versus high, etc.). Thus, an analytics result of target player injury likelihood generated in the first month of a season means the same as an analytics result of target player injury likelihood generated in the last month of the season. Certain examples analyze a probability of injury, minimum and maximum values, and possible thresholds to find a distribution of values and determine thresholds to keep the distribution between low/med/high consistent across time periods.

While examples disclosed and described herein have focused on sports medicine and injury data/probability, certain examples can apply to other environments and other types of information. For example, with player injury information, a risk or probability of injury increases as the season goes along, and a dynamic threshold adapts over time to accommodate the increased injury risk and change in distribution of players. In healthcare, patient biometric information (e.g., heart rate, blood pressure, etc.) changes as the patient gets older, and a dynamic threshold can adapt over time to patient age, for example. In meteorology, weather-related data such as rainfall, etc., changes throughout the year as an impact of accumulation of rainfall in a dry season is different from an impact of rainfall accumulation in a rainy season. A dynamic threshold can adapt to time of year in weather analysis, for example. In finance, information distribution can vary based on a country's economics. For example, a distribution of people having certain bank accounts in America will be different from a distribution of people having the same types of bank accounts in India. A dynamic threshold can be adaptive to the economics of the target country or region, for example.

Thus, certain examples can apply to data in which a data distribution changes over time. In certain examples, when a data distribution changes over time, a dynamic threshold adapts dynamically along with changes in the data and data distribution.

Example 1 is a method including analyzing, by executing an instruction with at least one processor, a set of probabilities of injury to determine a minimum probability and a maximum probability in the set of probabilities of injury based on a request for an injury risk for a target player. The method of example 1 also includes determining, by executing an instruction with the at least one processor, possible thresholds to divide the set of probabilities of injury between the minimum probability and the maximum probability. The method of example 1 further includes converting, by executing an instruction with the at least one processor, the probabilities of injury into percentages of injury based on at least one of the possible thresholds. The method of example 1 includes distributing, by executing an instruction with the at least one processor, the percentages of injury into a plurality of bands based on one or more of the possible thresholds. The method of example 1 includes comparing, by executing an instruction with the at least one processor, the percentages of injury in each of the plurality of bands according to a criterion. The method of example 1 includes, when the criterion is satisfied, updating, by executing an instruction with the at least one processor, a target threshold to classify the injury risk for the target player based on at least one of the possible thresholds dividing the percentages of injury in the plurality of bands and outputting the injury risk for the target player.

Example 2 includes the subject matter of example 1, wherein converting, by executing an instruction with the at least one processor, the probabilities of injury into percentages of injury based on at least one of the possible thresholds includes comparing a first probability of injury to a maximum threshold and a minimum threshold formed by applying a tolerance to a first threshold from the possible thresholds.

Example 3 includes the subject matter of example 2, wherein, when the first probability of injury is less than the minimum threshold, a first percentage of injury is determined based on a relationship of a slope of probability with respect to threshold for data between the minimum threshold and the first threshold multiplied by the first probability of injury.

Example 4 includes the subject matter of example 2, wherein, when the first probability of injury is greater than the maximum threshold, a first percentage of injury is determined based on a relationship of a slope of probability with respect to threshold for data between the first threshold and the maximum threshold multiplied by the first probability of injury.

Example 5 includes the subject matter of example 1, wherein distributing, by executing an instruction with the at least one processor, the percentages of injury into a plurality of bands based on one or more of the possible thresholds includes comparing a number of actual injuries in each of the plurality of bands to a total number of injuries in the respective band.

Example 6 includes the subject matter of example 1, wherein the plurality of bands includes a normal risk band, an elevated risk band, and a significant risk band.

Example 7 includes the subject matter of example 1, wherein the risk injury for the target player classifies the target player in one of the plurality of bands based on information in the plurality of bands enabling comparison of the target player to one or more second players having similarities to the target player.

Example 8 is a tangible machine readable storage medium including instructions that, when executed, cause at least one processor to at least analyze a set of probabilities of injury to determine a minimum probability and a maximum probability in the set of probabilities of injury based on a request for an injury risk for a target player. The instructions of example 8, when executed, cause at least one processor to determine possible thresholds to divide the set of probabilities of injury between the minimum probability and the maximum probability. The instructions of example 8, when executed, cause at least one processor to convert the probabilities of injury into percentages of injury based on at least one of the possible thresholds. The instructions of example 8, when executed, cause at least one processor to distribute the percentages of injury into a plurality of bands based on one or more of the possible thresholds. The instructions of example 8, when executed, cause at least one processor to compare the percentages of injury in each of the plurality of bands according to a criterion. The instructions of example 8, when executed, cause at least one processor to, when the criterion is satisfied, update a target threshold to classify the injury risk for the target player based on at least one of the possible thresholds dividing the percentages of injury in the plurality of bands and outputting the injury risk for the target player.

Example 9 includes the subject matter of example 8, wherein converting the probabilities of injury into percentages of injury based on at least one of the possible thresholds includes comparing a first probability of injury to a maximum threshold and a minimum threshold formed by applying a tolerance to a first threshold from the possible thresholds.

Example 10 includes the subject matter of example 9, wherein, when the first probability of injury is less than the minimum threshold, a first percentage of injury is determined based on a relationship of a slope of probability with respect to threshold for data between the minimum threshold and the first threshold multiplied by the first probability of injury.

Example 11 includes the subject matter of example 9, wherein, when the first probability of injury is greater than the maximum threshold, a first percentage of injury is determined based on a relationship of a slope of probability with respect to threshold for data between the first threshold and the maximum threshold multiplied by the first probability of injury.

Example 12 includes the subject matter of example 8, wherein distributing the percentages of injury into a plurality of bands based on one or more of the possible thresholds includes comparing a number of actual injuries in each of the plurality of bands to a total number of injuries in the respective band.

Example 13 includes the subject matter of example 8, wherein the plurality of bands includes a normal risk band, an elevated risk band, and a significant risk band.

Example 14 includes the subject matter of example 8, wherein the risk injury for the target player classifies the target player in one of the plurality of bands based on information in the plurality of bands enabling comparison of the target player to one or more second players having similarities to the target player.

Example 15 is an apparatus including at least one processor and memory to execute instructions. The instructions, when executed, to at least implement a probability evaluator to analyze a set of probabilities of injury to determine a minimum probability and a maximum probability in the set of probabilities of injury based on a request for an injury risk for a target player. The instructions, when executed, to at least implement a threshold determiner to determine possible thresholds to divide the set of probabilities of injury between the minimum probability and the maximum probability. The instructions, when executed, to at least implement a probability converter to convert the probabilities of injury into percentages of injury based on at least one of the possible thresholds. The instructions, when executed, to at least implement a band creator to distribute the percentages of injury into a plurality of bands based on one or more of the possible thresholds. The instructions, when executed, to at least implement a band evaluator to compare the percentages of injury in each of the plurality of bands according to a criterion, and, when the criterion is satisfied, to update a target threshold to classify the injury risk for the target player based on at least one of the possible thresholds dividing the percentages of injury in the plurality of bands. The instructions, when executed, to at least implement a threshold output processor to output the updated target threshold and the injury risk for the target player.

Example 16 includes the subject matter of example 15, wherein the probability converter is to convert the probabilities of injury into percentages of injury based on at least one of the possible thresholds includes comparing a first probability of injury to a maximum threshold and a minimum threshold formed by applying a tolerance to a first threshold from the possible thresholds.

Example 17 includes the subject matter of example 16, wherein, when the first probability of injury is less than the minimum threshold, a first percentage of injury is determined based on a relationship of a slope of probability with respect to threshold for data between the minimum threshold and the first threshold multiplied by the first probability of injury.

Example 18 includes the subject matter of example 16, wherein, when the first probability of injury is greater than the maximum threshold, a first percentage of injury is determined based on a relationship of a slope of probability with respect to threshold for data between the first threshold and the maximum threshold multiplied by the first probability of injury.

Example 19 includes the subject matter of example 15, wherein the band creator distributes the percentages of injury into a plurality of bands based on one or more of the possible thresholds includes comparing a number of actual injuries in each of the plurality of bands to a total number of injuries in the respective band.

Example 20 includes the subject matter of example 15, wherein the risk injury for the target player classifies the target player in one of the plurality of bands based on information in the plurality of bands enabling comparison of the target player to one or more second players having similarities to the target player.

Example 21 includes the subject matter of any of examples 15-20, wherein the target player is an athlete and wherein the injury is a sports-related injury.

Example 22 includes the subject matter of any of examples 8-14, wherein the target player is an athlete and wherein the injury is a sports-related injury.

Example 23 includes the subject matter of any of examples 1-7, wherein the target player is an athlete and wherein the injury is a sports-related injury.

Example 24 includes the subject matter of any of examples 1-7, further including updating, as data is gathering during a season, the threshold to maintain a distribution of the percentages of injury among the plurality of bands throughout the season.

Example 25 is an apparatus including a means for probability evaluation to analyze a set of probabilities of injury to determine a minimum probability and a maximum probability in the set of probabilities of injury based on a request for an injury risk for a target player. The apparatus of example 25 includes a means for threshold determination to determine possible thresholds to divide the set of probabilities of injury between the minimum probability and the maximum probability. The apparatus of example 25 includes a means for probability conversion to convert the probabilities of injury into percentages of injury based on at least one of the possible thresholds. The apparatus of example 25 includes a means for band creation to distribute the percentages of injury into a plurality of bands based on one or more of the possible thresholds. The apparatus of example 25 includes a means for band evaluation to compare the percentages of injury in each of the plurality of bands according to a criterion, and, when the criterion is satisfied, to update a target threshold to classify the injury risk for the target player based on at least one of the possible thresholds dividing the percentages of injury in the plurality of bands. The apparatus of example 25 includes a means for threshold output to output the injury risk for the target player.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. A method comprising:
analyzing, by executing an instruction with at least one processor, a set of probabilities of injury to determine a minimum probability and a maximum probability in the set of probabilities of injury based on a request for an injury risk for a target player;
determining, by executing an instruction with the at least one processor, possible thresholds to divide the set of probabilities of injury between the minimum probability and the maximum probability;
converting, by executing an instruction with the at least one processor, the probabilities of injury into percentages of injury based on at least one of the possible thresholds;
distributing, by executing an instruction with the at least one processor, the percentages of injury into a plurality of bands based on one or more of the possible thresholds;
comparing, by executing an instruction with the at least one processor, the percentages of injury in each of the plurality of bands according to a criterion; and
when the criterion is satisfied, updating, by executing an instruction with the at least one processor, a target threshold to classify the injury risk for the target player based on at least one of the possible thresholds dividing the percentages of injury in the plurality of bands and outputting the injury risk for the target player.

2. The method of claim 1, wherein converting, by executing an instruction with the at least one processor, the probabilities of injury into percentages of injury based on at least one of the possible thresholds includes comparing a first probability of injury to a maximum threshold and a minimum threshold formed by applying a tolerance to a first threshold from the possible thresholds.

3. The method of claim 2, wherein, when the first probability of injury is less than the minimum threshold, a first percentage of injury is determined based on a relationship of a slope of probability with respect to threshold for data between the minimum threshold and the first threshold multiplied by the first probability of injury.

4. The method of claim 2, wherein, when the first probability of injury is greater than the maximum threshold, a first percentage of injury is determined based on a relationship of a slope of probability with respect to threshold for data between the first threshold and the maximum threshold multiplied by the first probability of injury.

5. The method of claim 1, wherein distributing, by executing an instruction with the at least one processor, the percentages of injury into a plurality of bands based on one or more of the possible thresholds includes comparing a number of actual injuries in each of the plurality of bands to a total number of injuries in the respective band.

6. The method of claim 1, wherein the plurality of bands includes a normal risk band, an elevated risk band, and a significant risk band.

7. The method of claim 1, wherein the risk injury for the target player classifies the target player in one of the plurality of bands based on information in the plurality of bands enabling comparison of the target player to one or more second players having similarities to the target player.

8. A tangible machine readable storage medium comprising instructions that, when executed, cause at least one processor to at least:
analyze a set of probabilities of injury to determine a minimum probability and a maximum probability in the set of probabilities of injury based on a request for an injury risk for a target player;
determine possible thresholds to divide the set of probabilities of injury between the minimum probability and the maximum probability;
convert the probabilities of injury into percentages of injury based on at least one of the possible thresholds;
distribute the percentages of injury into a plurality of bands based on one or more of the possible thresholds;
compare the percentages of injury in each of the plurality of bands according to a criterion; and
when the criterion is satisfied, update a target threshold to classify the injury risk for the target player based on at least one of the possible thresholds dividing the percentages of injury in the plurality of bands and outputting the injury risk for the target player.

9. The machine readable storage medium of claim 8, wherein converting the probabilities of injury into percentages of injury based on at least one of the possible thresholds includes comparing a first probability of injury to a maximum threshold and a minimum threshold formed by applying a tolerance to a first threshold from the possible thresholds.

10. The machine readable storage medium of claim 9, wherein, when the first probability of injury is less than the minimum threshold, a first percentage of injury is determined based on a relationship of a slope of probability with respect to threshold for data between the minimum threshold and the first threshold multiplied by the first probability of injury.

11. The machine readable storage medium of claim 9, wherein, when the first probability of injury is greater than the maximum threshold, a first percentage of injury is determined based on a relationship of a slope of probability with respect to threshold for data between the first threshold and the maximum threshold multiplied by the first probability of injury.

12. The machine readable storage medium of claim 8, wherein distributing the percentages of injury into a plurality of bands based on one or more of the possible thresholds includes comparing a number of actual injuries in each of the plurality of bands to a total number of injuries in the respective band.

13. The machine readable storage medium of claim 8, wherein the plurality of bands includes a normal risk band, an elevated risk band, and a significant risk band.

14. The machine readable storage medium of claim 8, wherein the risk injury for the target player classifies the target player in one of the plurality of bands based on information in the plurality of bands enabling comparison of the target player to one or more second players having similarities to the target player.

15. An apparatus comprising:
at least one processor and memory to execute instructions to at least implement:
a probability evaluator to analyze a set of probabilities of injury to determine a minimum probability and a maximum probability in the set of probabilities of injury based on a request for an injury risk for a target player;
a threshold determiner to determine possible thresholds to divide the set of probabilities of injury between the minimum probability and the maximum probability;
a probability converter to convert the probabilities of injury into percentages of injury based on at least one of the possible thresholds;
a band creator to distribute the percentages of injury into a plurality of bands based on one or more of the possible thresholds;
a band evaluator to compare the percentages of injury in each of the plurality of bands according to a criterion, and, when the criterion is satisfied, to update a target threshold to classify the injury risk for the target player based on at least one of the possible thresholds dividing the percentages of injury in the plurality of bands; and
a threshold output processor to output the updated target threshold and the injury risk for the target player.

16. The apparatus of claim 15, wherein the probability converter is to convert the probabilities of injury into percentages of injury based on at least one of the possible thresholds includes comparing a first probability of injury to a maximum threshold and a minimum threshold formed by applying a tolerance to a first threshold from the possible thresholds.

17. The apparatus of claim 16, wherein, when the first probability of injury is less than the minimum threshold, a first percentage of injury is determined based on a relationship of a slope of probability with respect to threshold for data between the minimum threshold and the first threshold multiplied by the first probability of injury.

18. The apparatus of claim 16, wherein, when the first probability of injury is greater than the maximum threshold, a first percentage of injury is determined based on a relationship of a slope of probability with respect to threshold for data between the first threshold and the maximum threshold multiplied by the first probability of injury.

19. The apparatus of claim 15, wherein the band creator distributes the percentages of injury into a plurality of bands based on one or more of the possible thresholds includes comparing a number of actual injuries in each of the plurality of bands to a total number of injuries in the respective band.

20. The apparatus of claim 15, wherein the risk injury for the target player classifies the target player in one of the plurality of bands based on information in the plurality of bands enabling comparison of the target player to one or more second players having similarities to the target player.

21.-25. (canceled)
